(19) United States
(12) Patent Application Publication
(10) Pub. No.: US 2006/0207262 A1
(43) Pub. Date: Sep. 21, 2006

(54) Coal fired gas turbine for district heating

(76) Inventor: Joseph Carl Firey, Seattle, WA (US)

Correspondence Address: Joseph C. Firey, P.O.Box 15514, Seattle, WA, 98115, US

(21) Appl. No.: 11/153,872

(22) Filed: Jun. 16, 2005

Related U.S. Application Data
(60) Provisional application No. 60/661,768, filed on Mar. 16, 2005.

(51) Int. Cl. F02C 6/00

(52) U.S. Cl. 60/784

(57) ABSTRACT

A district heating system is described, for heating several homes and businesses in a district. The hot exhaust gas, of a gas turbine engine, is saturated with water vapor, and then passed through each home heater, where condensation of the water vapor provides heat to each home. With low cost coal fuel, burned in the gas turbine engine burner, a large portion of the fuel energy is efficiently utilized for home heating and electric power generation. In this way, low cost domestic coal can replace expensive imported petroleum fuels for home heating and electric power generation.

### SUMMARY OF THE INVENTION

The hot exhaust gas, from a gas turbine engine, is mixed with liquid water to create a water vapor saturated gas. Within the several home heat exchangers, through which this gas is passed, the condensation of this water vapor transfers heat into the home air, and thus heats the several homes within the district. The gas turbine engine also generates electric power, and the combined heating and electric load can equal 70 to 90 percent of the fuel energy supplied to the gas turbine burner.

Preferably coal is the principal fuel for the gas turbine engine burner, though other fuels can be used, alternatively, or in combination with coal. An example mixed fuel coal burner for gas turbine engines, is described in my related U.S. patent application, Ser. No. 11/103228.

In this way very efficient fuel utilization is obtained, and low cost coal can replace expensive furnace oil, and natural gas, for home heating. Such substitution of domestic coal for imported petroleum fuels, will also improve national energy independence, and the trade balance.

### BACKGROUND OF THE INVENTION

1. Field of the Invention

This invention is in the field of district heating plants for supplying electric power and heating to a district or city of homes and businesses.

2. Description of the Prior Art

District heating plants are rather widely used, in some European nations, for supplying heating and electric power to all, or a portion, of a city. Usually these prior art district heating systems comprise a high pressure steam boiler, supplying steam to a steam turbine, which generates electric power. The exhaust steam from the turbine can be distributed in pipes throughout the district. Each home or business served within the district, connects into the steam distributor, and passes steam through a home heat exchanger, to heat the home air. The condensate from each home exchange is collected in a collector pipe, to be returned to the steam boiler. In this way electric power and home heating are supplied to the district. Various types of fuels, including low cost, and widely available, coal, can be fired in the boiler. At least seventy percent, to 90 percent, of the fuel energy is thus efficiently utilized.

An alternative system passes the turbine exhaust steam into a single large heat exchanger, to create a flow of hot water, which becomes the heating fluid for the connected homes and businesses. The cooled circulating water is returned, via collector pipes, to the large heat exchanger.

These prior art district heating plants, using a high pressure steam boiler, require the attendance of several qualified boiler operators, at all times, resulting in high personnel costs. To reduce personnel costs, per unit of energy output, these prior art plants commonly use very large single boiler plants to serve an entire city. As a result, a large, up front capital investment is required, and with installation time being long, returns on this capital are appreciably delayed. It is perhaps for these financial reasons that very few district heating plants exist in the United States.

It would be desirable to have available district heating plants which were wholly automated, and thus required very low personnel costs per unit of output, and were of moderate capital cost. In this way, small plants, with short installation time, and quick returns on capital, could be used advantageously in the United States. Very preferably, these small district heating plants are to be capable of using low cost, and readily available, coal fuel as the primary energy source.

### CROSS REFERENCES TO RELATED APPLICATIONS

My provisional U.S. patent application entitled, “Coal Fired Gas Turbine for District Heating,” No. 60/661768, filed 16 Mar. 2005, is a preliminary description of the invention described herein.

The mixed fuel coal burner for gas turbine engines, described in my earlier filed U.S. patent application Ser. No. 11/103228, is an example of a mixed fuel coal burner suitable for use with the coal fired gas turbine district heating system of this invention.

### BRIEF DESCRIPTION OF THE DRAWINGS

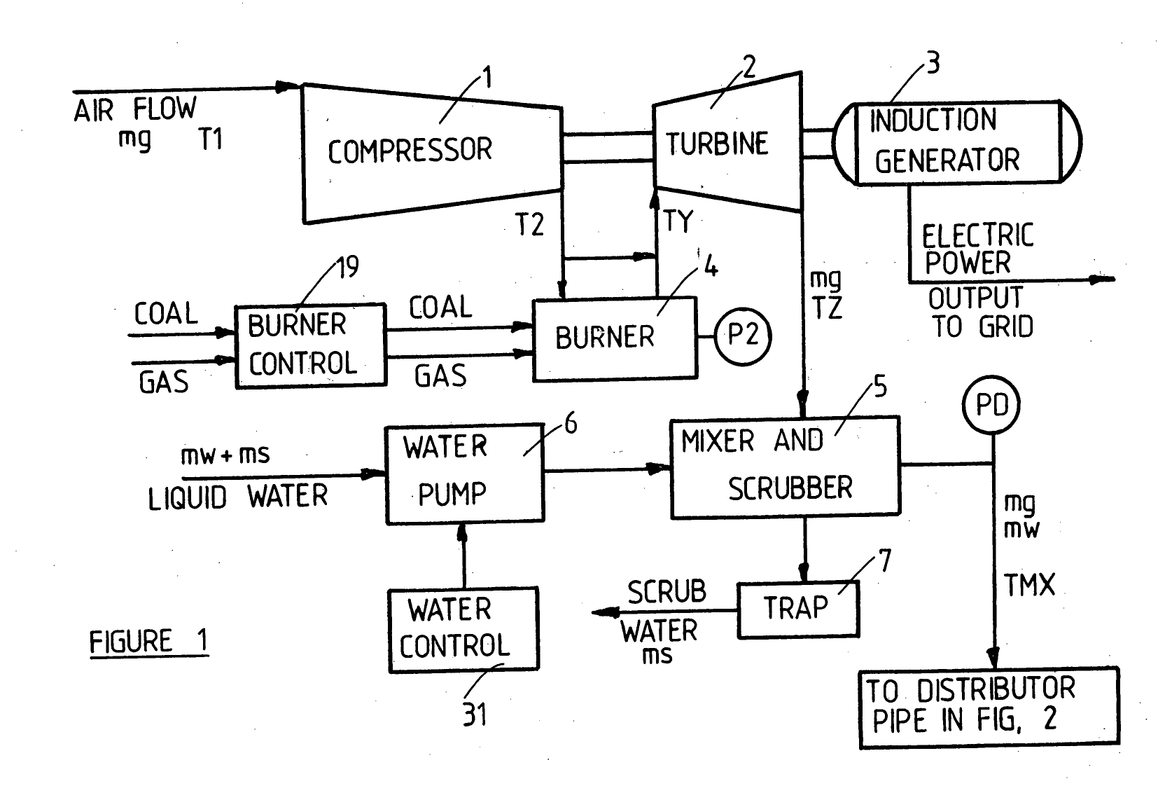

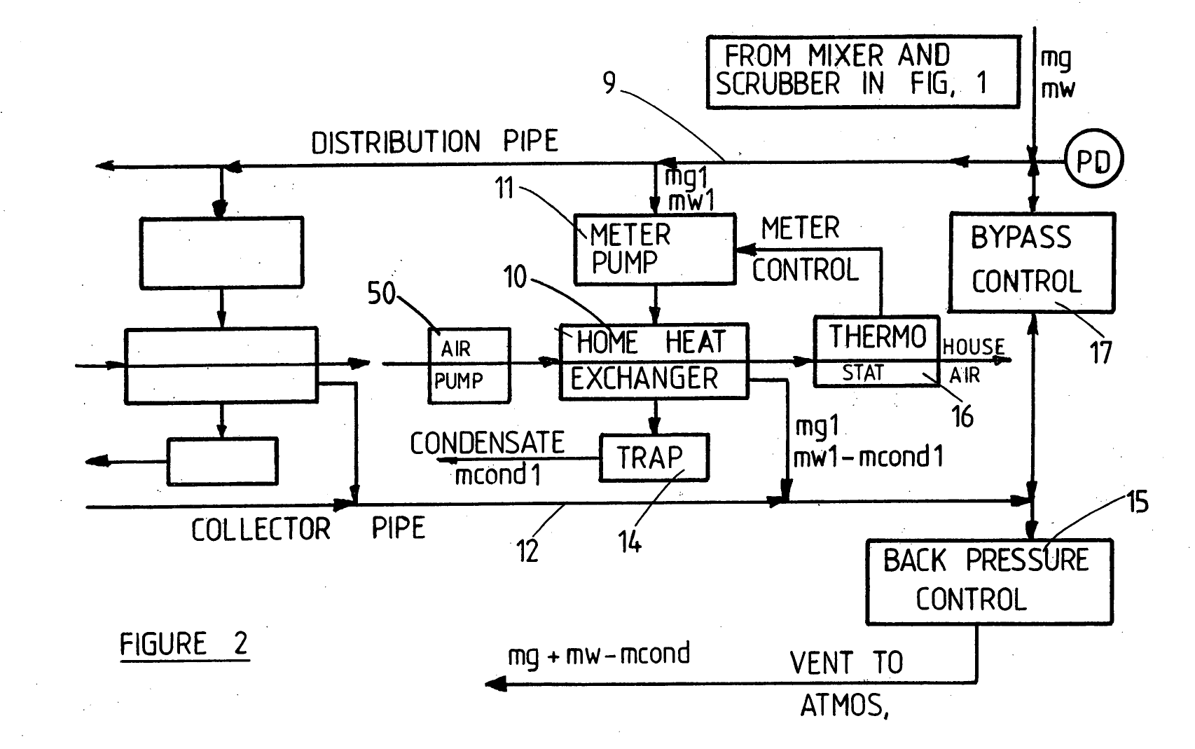

An example single turbine form of gas turbine energized district heating plant, of this invention, is shown schematically in FIG. 1, together with related FIG. 2.

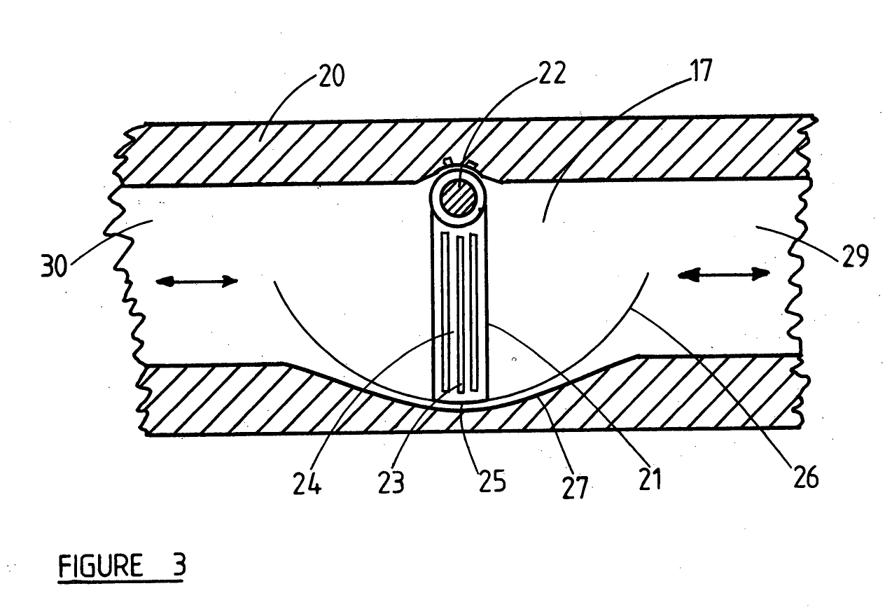

One type of bypass control is shown schematically in FIG. 3.

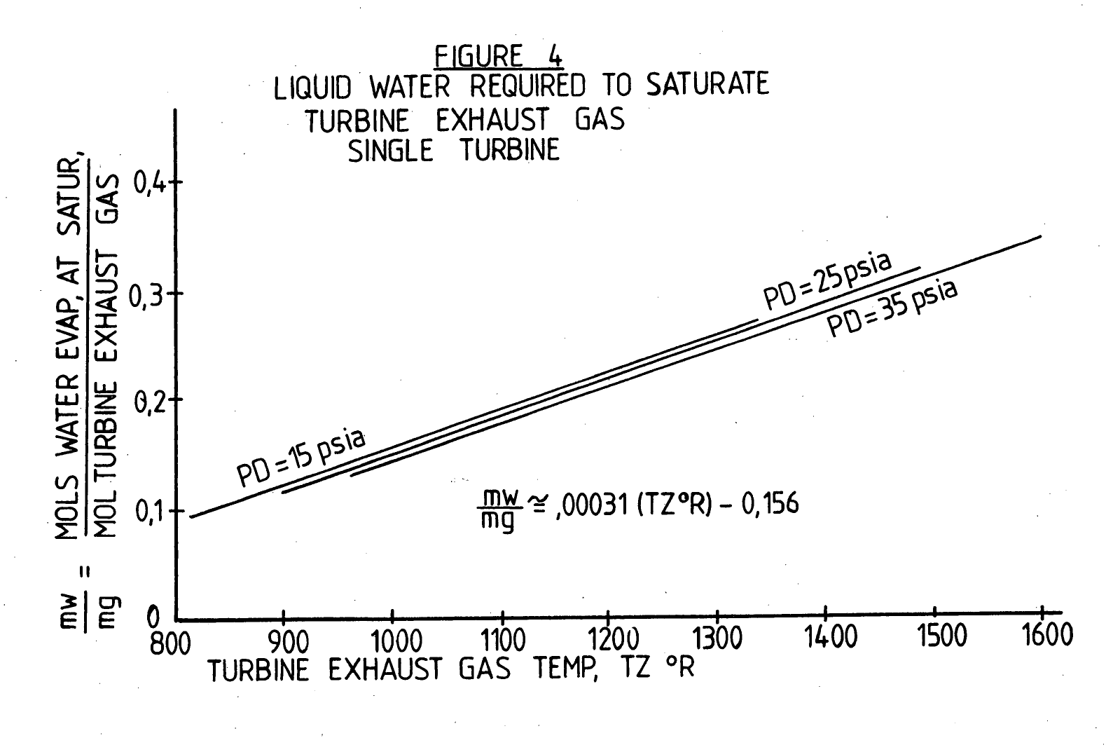

The flow rate of liquid water, into the mixer element, required to saturate the turbine exhaust gas passing therethrough, is illustrated in FIG. 4 for the single turbine form of the invention.

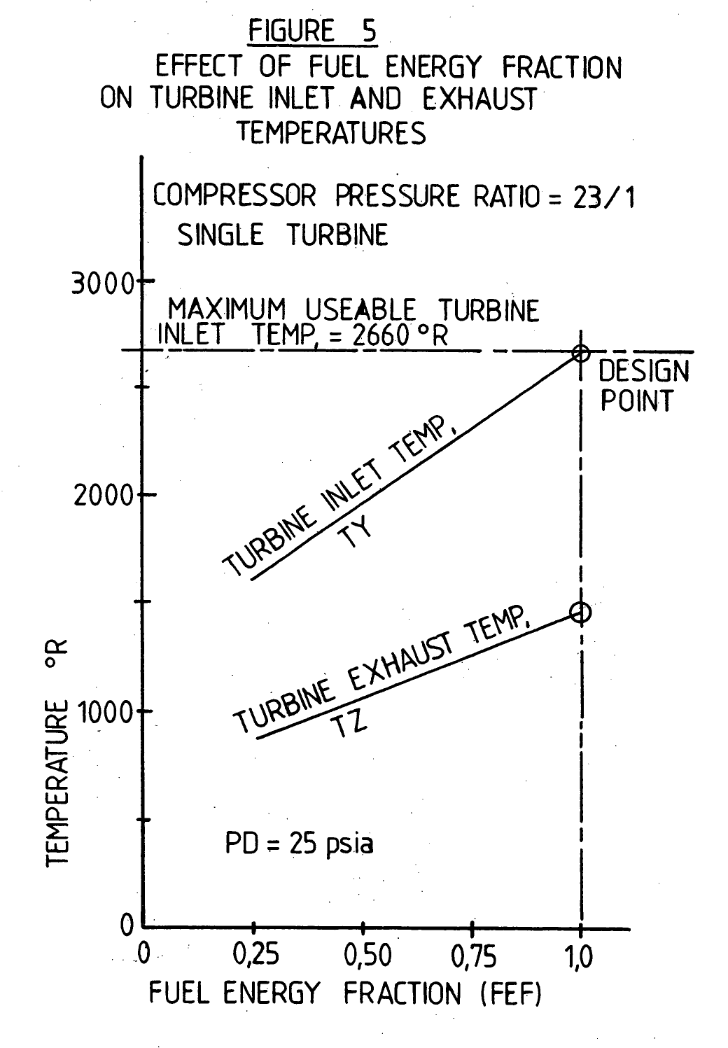

The effects of fuel burn rate, in the gas turbine engine burner, on turbine inlet and exhaust temperatures, is shown approximately in FIG. 5, in terms of the fraction of maximum fuel energy input, for a single turbine.

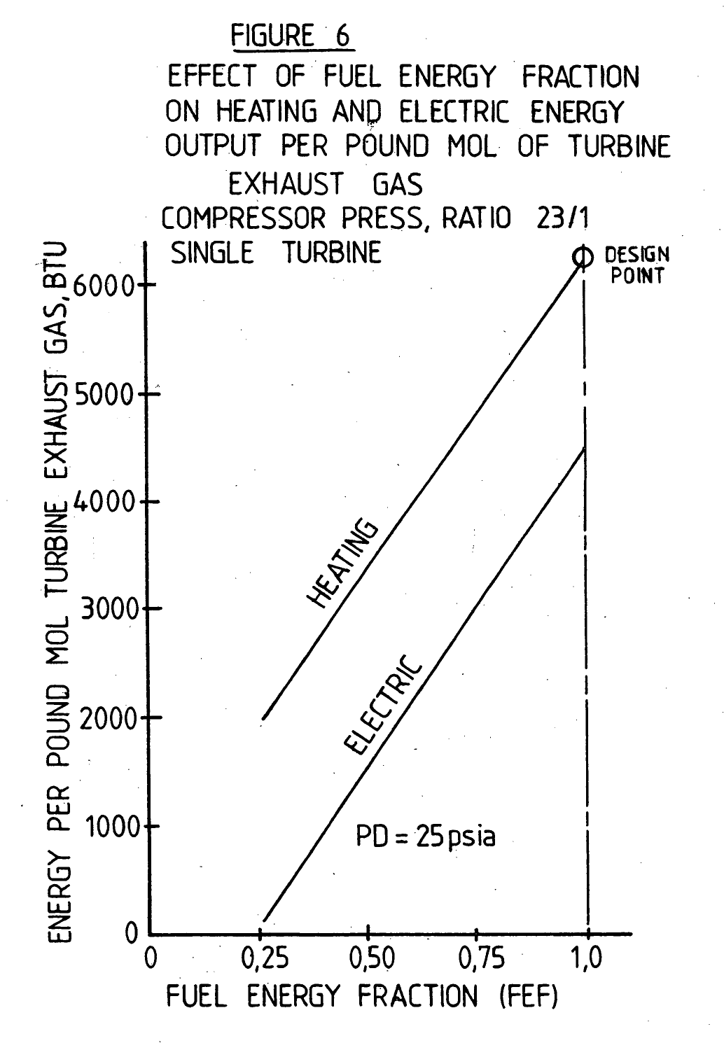

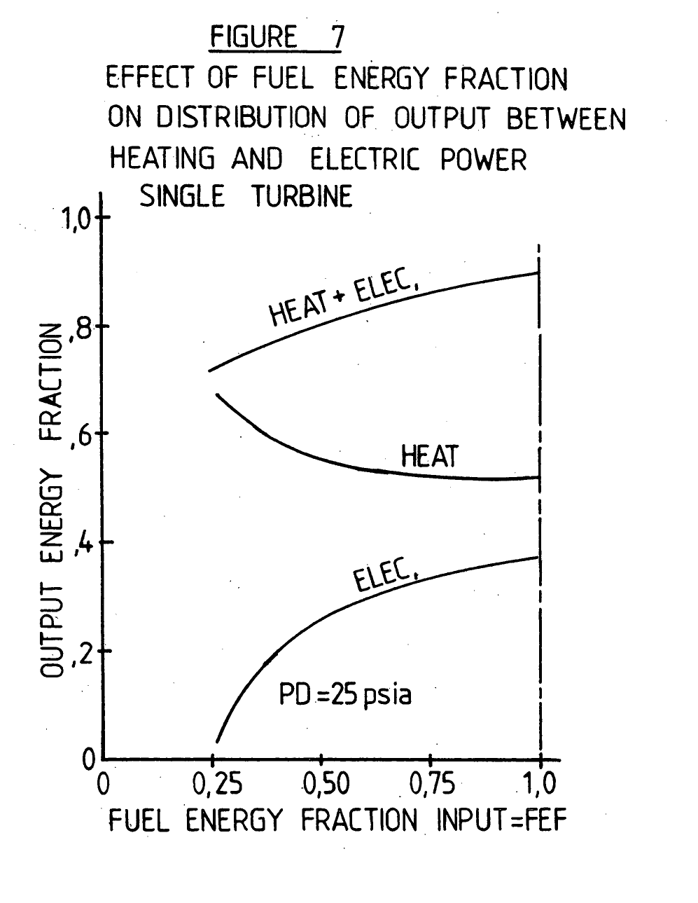

The effects of fuel burn rate, on useful energy output for electric power, and home heating, is shown approximately in FIG. 6, and FIG. 7, for a single turbine.

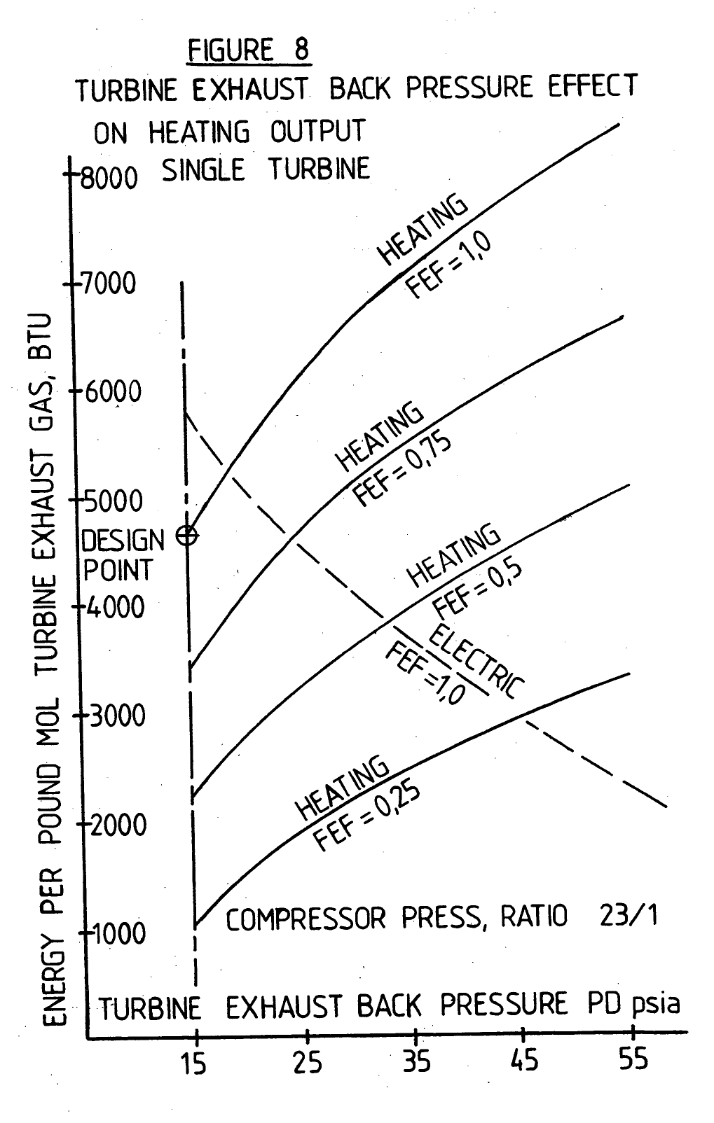

The use of increased turbine exhaust back pressure as a means of increasing heating output at the expense of electric power output is illustrated on FIG. 8, for a single turbine.

The above listed drawings, FIGS. 1 through 8, relate to the single turbine optional form of the invention illustrated in FIGS. 1 and 2.

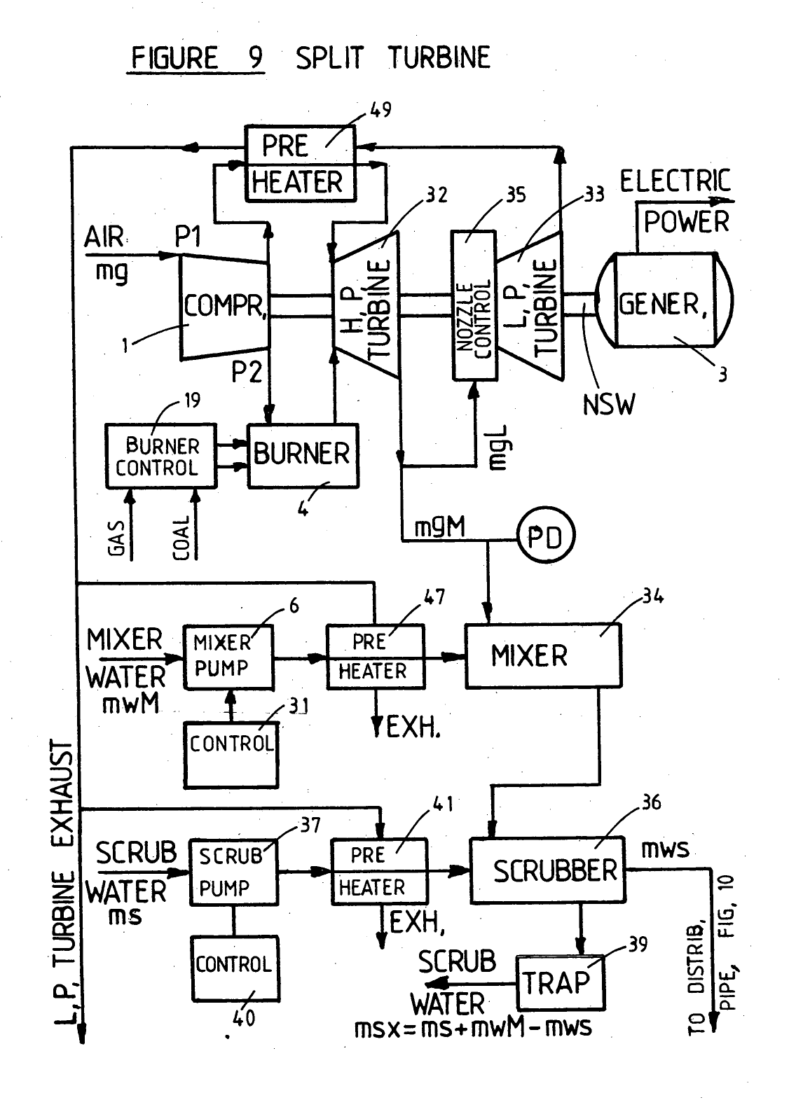

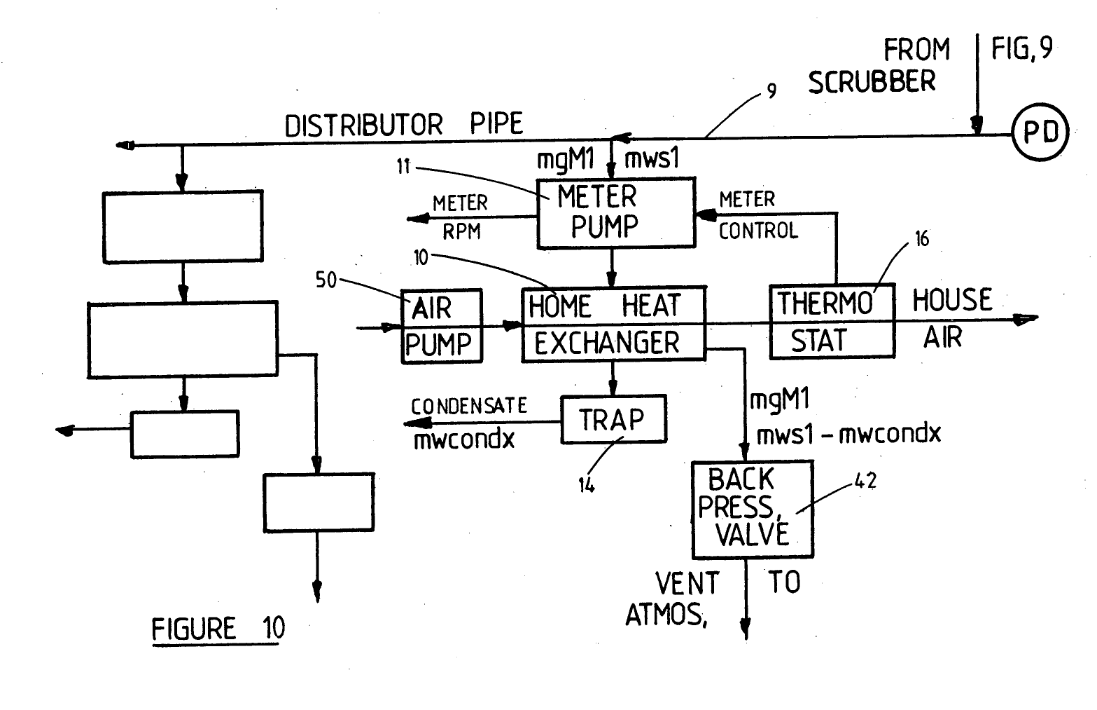

The following drawings, FIGS. 9 through 19, relate to the split turbine optional form of the invention illustrated schematically in FIGS. 9 and 10.

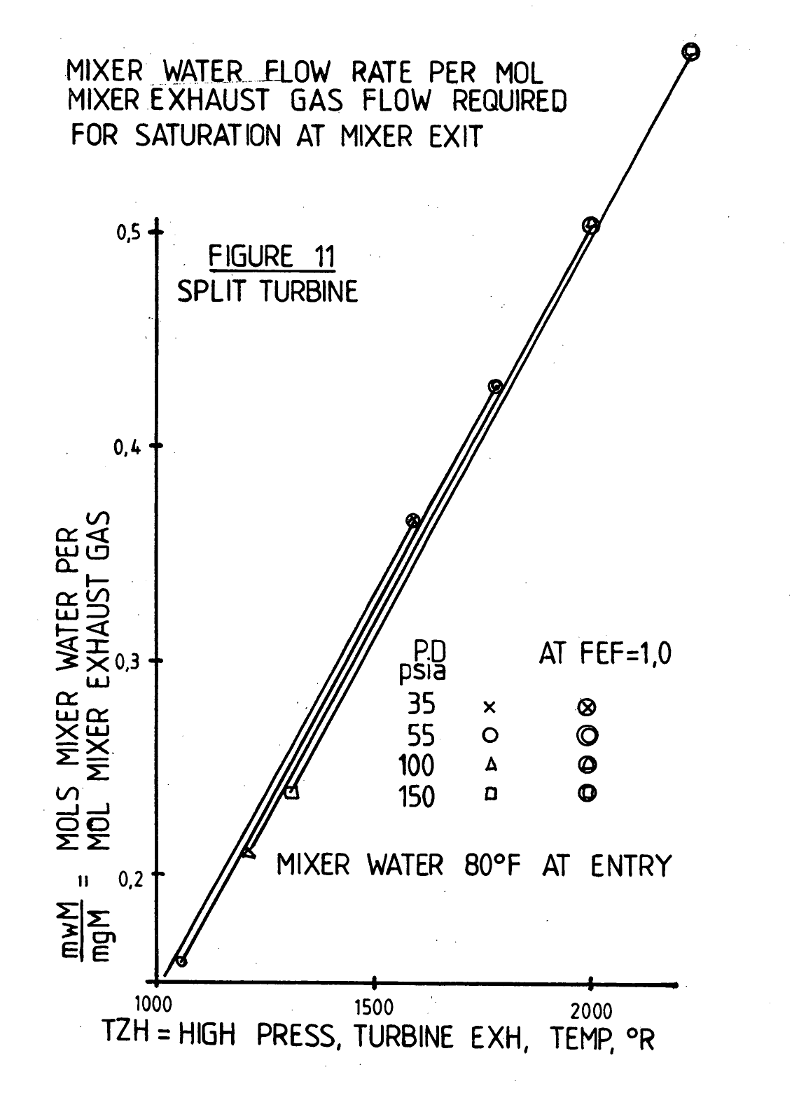

The mixer water flow rate required to fully saturate the high pressure turbine exhaust gas is shown on FIG. 11, versus the temperature of this exhaust gas.

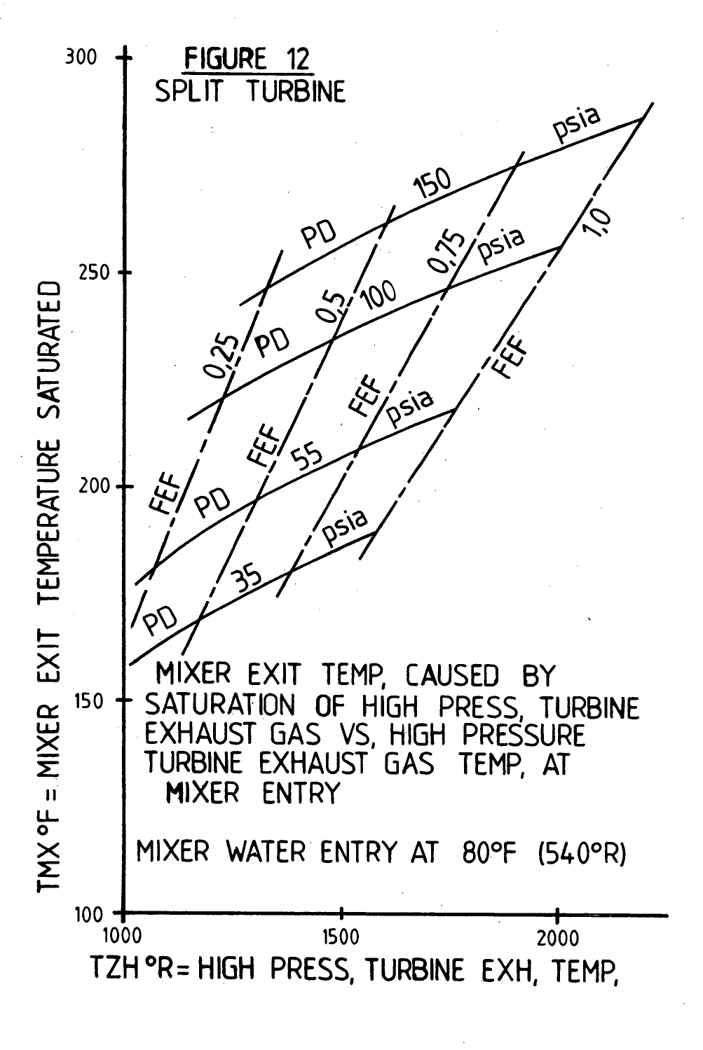

A chart of mixer gas exit temperature, versus high pressure turbine exhaust temperature, is shown in FIG. 12.

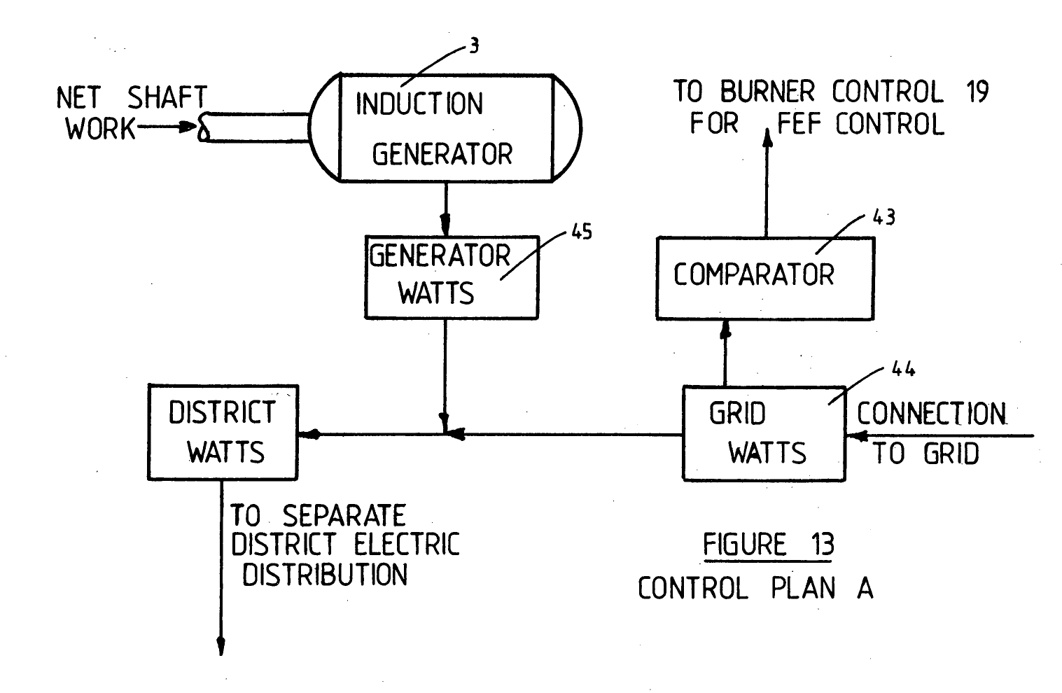

On FIG. 13, a burner control schematic diagram is shown, utilizing electric power sensors.

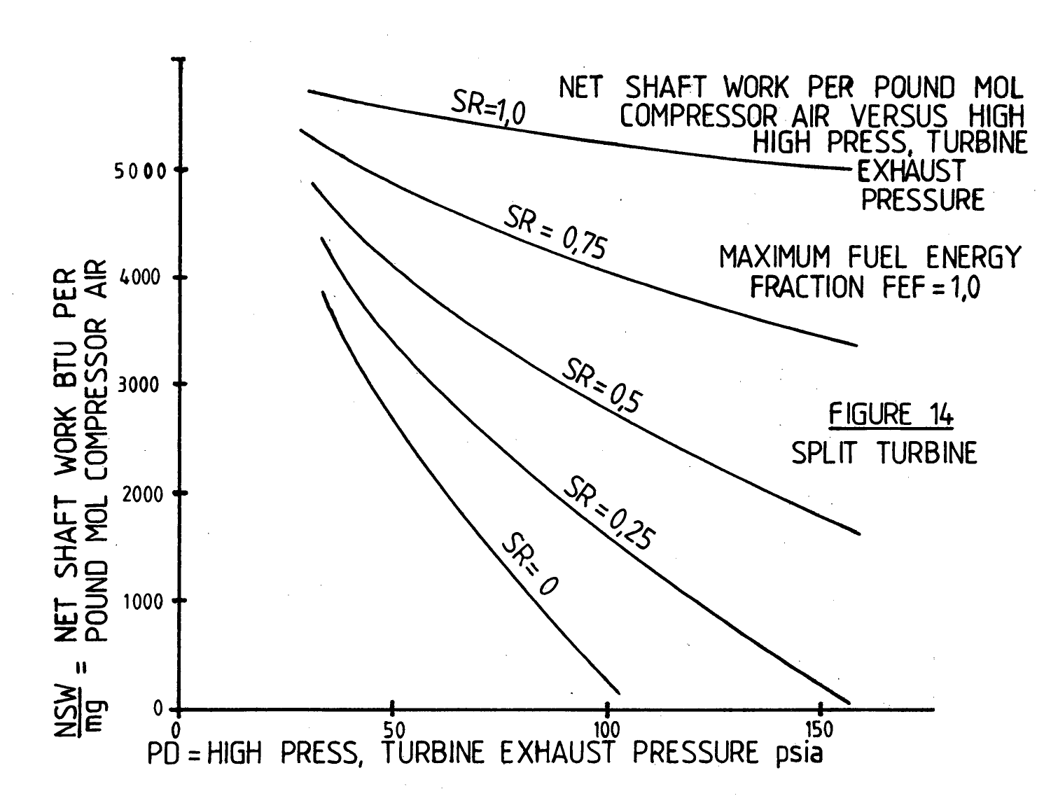

The effects of high pressure turbine exhaust pressure and split ratio on the net shaft work output of the turbines is shown on FIG. 14, at maximum fuel energy fraction.

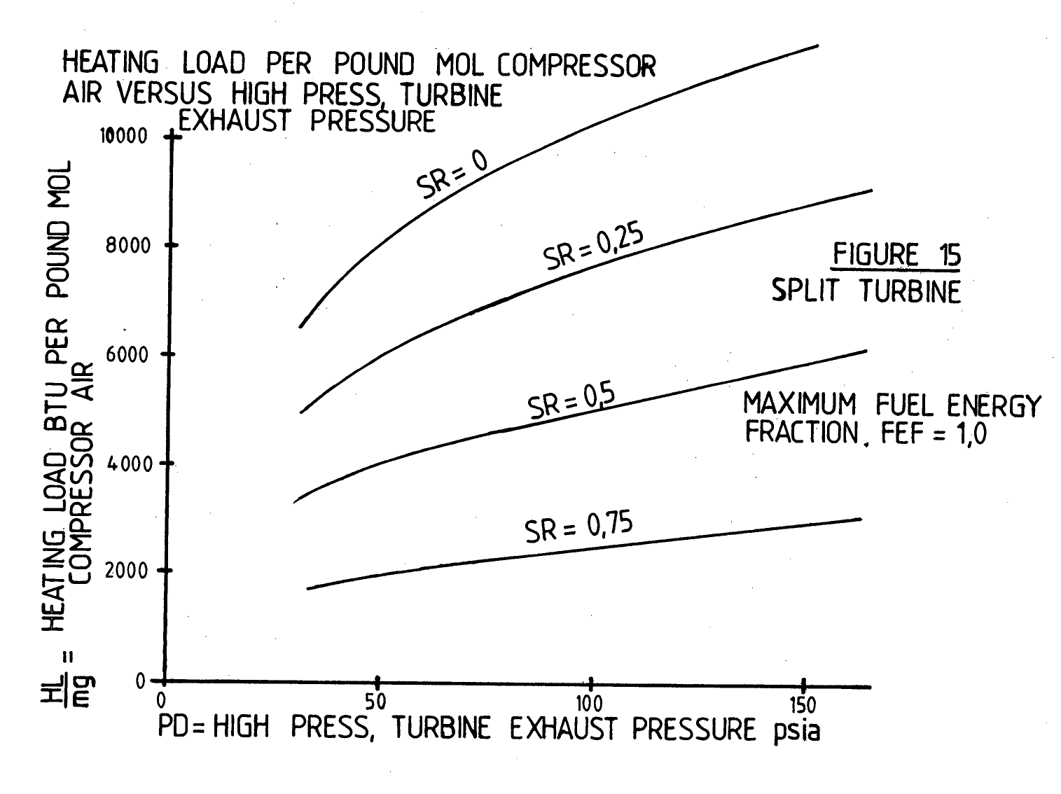

The effects of high pressure turbine exhaust pressure and split ratio on the heating load output of the plant is shown on FIG. 15, at maximum fuel energy fraction.

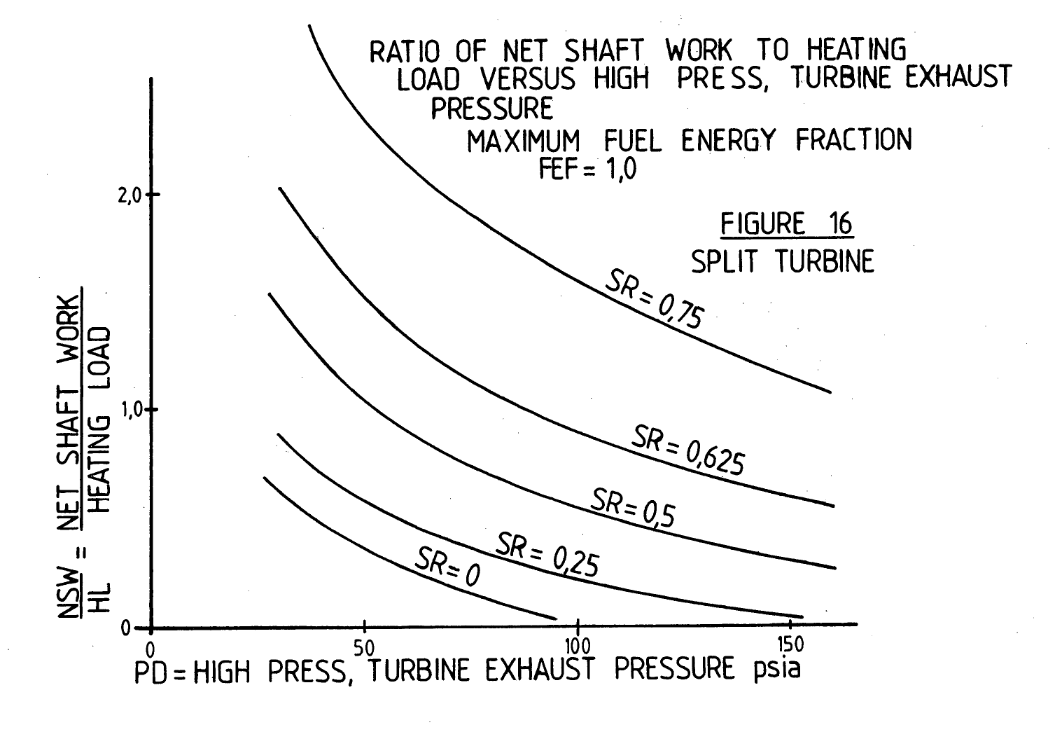

The relation of the ratio, of net shaft work to heating load, to high pressure turbine exhaust pressure, and split ratio, is shown on FIG. 16.

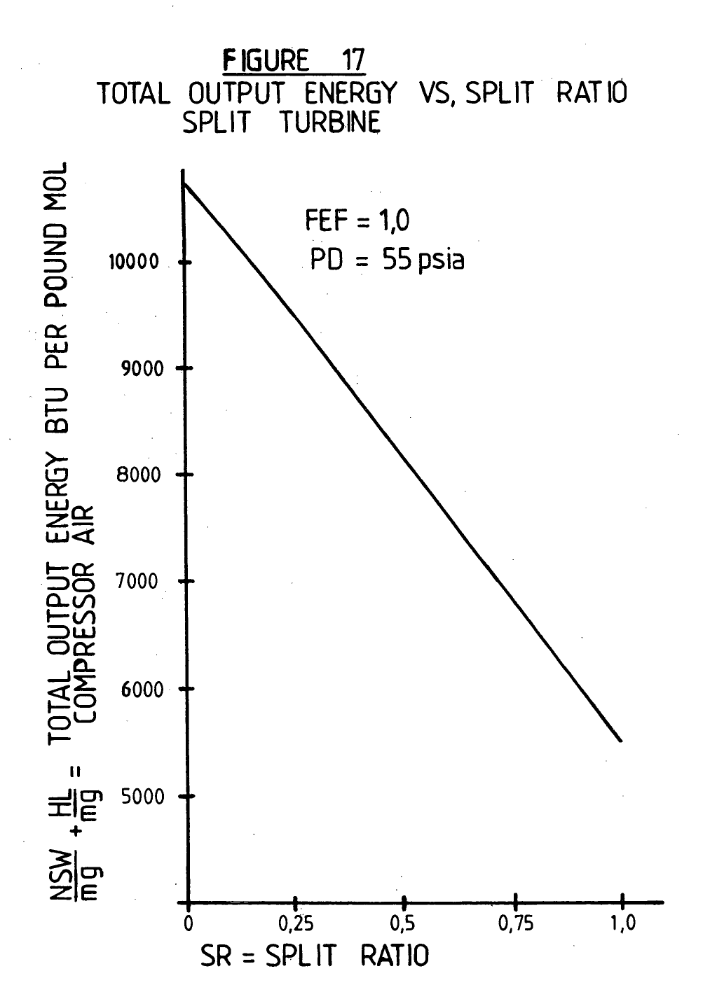

The effect of split ratio on the sum of net shaft work and heating load is shown in FIG. 17.

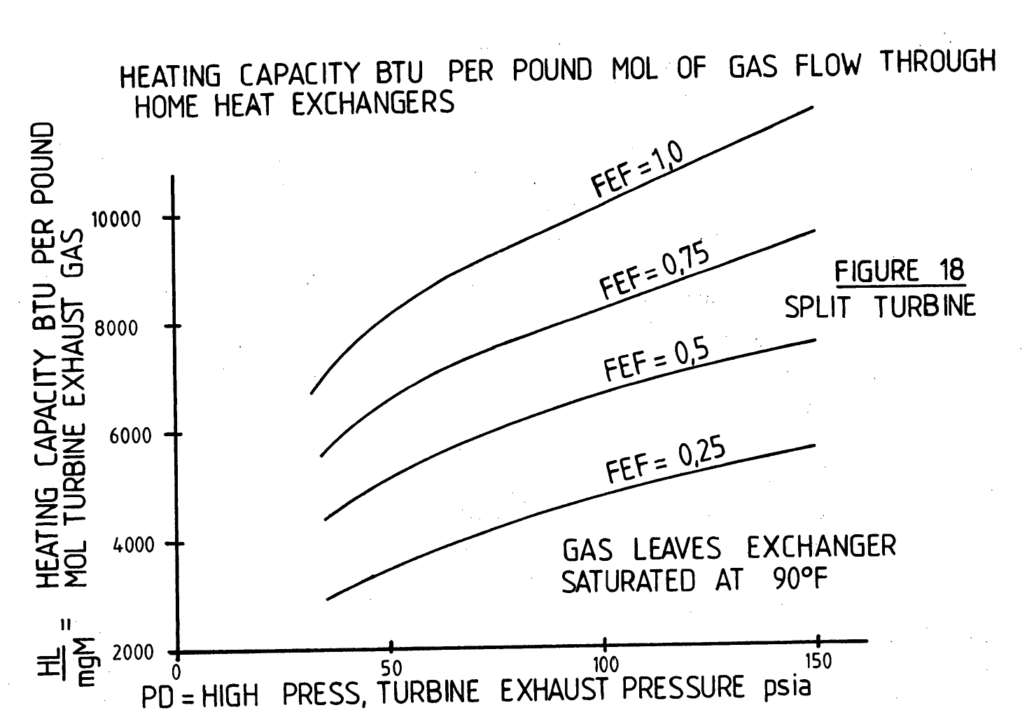

The heating capacity, per pound mol of high pressure turbine exhaust gas passed through a home heat exchanger, is shown on FIG. 18, versus high pressure turbine exhaust pressure and fuel energy fraction.

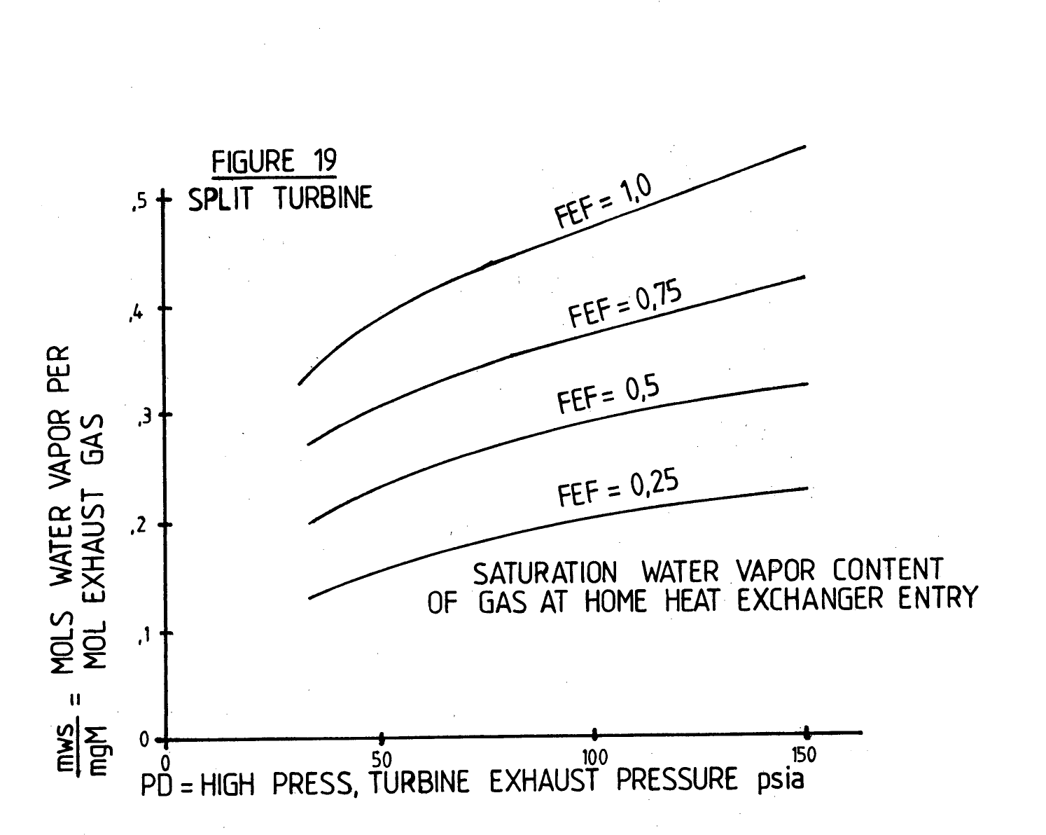

The water vapor content of the exhaust gas entering the home heat exchangers is shown on FIG. 19, versus high pressure turbine exhaust pressure and fuel energy fraction.

### DESCRIPTION OF THE PREFERRED EMBODIMENTS

A. Single Turbine Option

A schematic diagram of one form of coal fired gas turbine district heating system, of this invention, is shown schematically in FIG. 1, and the related FIG. 2, and comprises the following components:
1. The gas turbine engine comprises: an air compressor, 1, driven by the turbine, 2, which also drives the induction generator, 3. Air flows through, and is compressed within, the compressor, 1, and this compressor discharge air flows partially into the burner, 4, and partially bypasses the burner, in order to cool the hot burned gases leaving the burner. The burner air reacts with coal fuel, and/or natural gas fuel, within the burner, 4, and the resulting hot burned gases are mixed with the bypass air, and pass into the expander turbine, 2. This mixture of hot burned gases, and bypass air, expands through the turbine, 2, from burner pressure, P2, down to mixer and scrubber pressure, PD, performing net work as a result of the greater specific volume of the gases flowing through the turbine, 2, as compared to the air flowing through the compressor, 1. This net work drives the mechanically connected induction generator, 3, and the electric power thus created can be delivered into the local electric power grid.
The induction generator, 3, thusly connected into an electric power grid, will maintain an approximately constant shaft rotational speed on the mechanically connected turbine, 2, and compressor, 1, provided the power output of the induction generator is a small portion of the grid power. At essentially constant shaft rotational speed, the air mass flow rate, mg, through the compressor, 1, and turbine, 2, will also be approximately constant.
2. An example coal burner, suitable for use with the gas turbine engine of this invention, is described in my earlier filed U.S. patent application, Ser. No., 11/103228, entitled, “Mixed Fuel Coal Burner for Gas Turbine Engines,” filed 12 Apr. 2005, and this material is incorporated herein by reference thereto.
3. Exhaust gas flows, from the turbine exit, into the mixer and scrubber chamber, 5, where liquid water is sprayed into the exhaust gas, from the water delivery pump, 6. The hot turbine exhaust gas is cooled, by evaporating this liquid water, and preferably becomes fully saturated with water vapor. When coal, or other sulfur containing fuel, is being burned in the burner, the liquid water flow rate, into the mixer and scrubber, preferably exceeds that needed to saturate the turbine exhaust gas. This excess liquid water is then not evaporated, and functions to scrub sulfur acids, and nitrogen acids, out of the gases, and is collected in the bottom of the mixer and scrubber chamber, and discharged therefrom via the liquid scrub water trap, 7, into a receiver of scrub liquid, such as the sewer.
4. The now water vapor saturated, and cooled, turbine exhaust gases, pass into the distribution pipe, 9, on FIG. 2. The distribution pipe, 9, is located so as to serve the entire residential, or commercial, district to be heated by the gas turbine district heating system of this invention.
5. Each residential, or commercial, customer is equipped with a home heat exchanger system, 10, into the hot gas side of which a positive displacement meter pump, 11, pumps saturated turbine exhaust gas, from the distribution pipe, 9. Home air is pumped by the air pump, 50, through the cold gas side of the home heat exchanger, 10, and is heated up, while cooling down the exhaust gas. The cooled turbine exhaust gas flows out of the hot gas side into the collector pipe, 12. The collector pipe is also located so as to serve the entire residential, or commercial, district to be heated. Only two home heat exchangers, and connections, are shown on FIG. 2, but each customer will be thusly equipped.
6. The turbine exhaust gas will remain saturated with water vapor, throughout its passage through the hot gas side of the home heat exchanger. But, being colder at exit from the heat exchanger, the exhaust gas will contain appreciably less water vapor content than at entry to the heat exchanger. A large portion of the entry water vapor will condense on the heat exchange surfaces to transfer heat into the house air. The resulting condensate collects at the bottom of the home heat exchanger and is discharged therefrom via the liquid condensate trap, 14, into a receiver of condensed liquid, such as the sewer.
7. The major portion of the heat, transferred from the saturated turbine exhaust gas into the home air, is thusly transferred by condensation of water vapor. And this condensing heat transfer mode yields high coefficients of heat transfer while the gas is saturated, so that only moderate heat exchanger surface area is required in the home heat exchanger.
8. One of the beneficial objects of this invention results from the fact that most of the energy in the gas turbine exhaust gas, is transferred into the homes by a combination of direct contact water evaporation in the mixer, followed by condensation of this water in the home heat exchanger. Both of these energy transfer processes are rapid, and do not require the costly high pressure steam boilers used in prior art district heating systems.
9. The saturated, and cooled, turbine exhaust gas passes from the collector pipe, 12, into the back pressure control, 15, and out of the back pressure control into the atmosphere. Since turbine exhaust gas flow is approximately constant, a fixed area exit nozzle can be used as the back pressure control, when an essentially constant back pressure is to be used. In many applications the back pressure need be only sufficiently above atmospheric pressure to assure proper operation of the bypass control, 17, and the liquid traps, 7, 14.
In other applications an adjustable back pressure, above atmospheric, can be used to meet occasional large increases of heating load. Back pressure can be thusly adjusted with variable flow area controls, such as a group of fixed area exit nozzles, each equipped with an on-off valve. Other types of back pressure control can be used, as are well known in the prior art of back pressure valves.
10. The home thermostat, 16, senses house air temperature, and acts, via a controller, to adjust either the speed or the duration of operation of the meter pump, 11. Pump flow or duration are increased, when house air temperature drops below a set value. By thus increasing the net flow of saturated turbine exhaust gas, and accompanying condensable water vapor, heat transfer is increased in the home heat exchanger, to restore house air temperature to the set value.
11. A bypass control, 17, connects the distribution pipe, 9, to the collector pipe, 12, and the backpressure control, 15. Thus, when gas turbine exhaust flow exceeds the requirements of the several home heat exchangers, 10, this excess turbine exhaust gas bypasses the home heat exchangers and flows directly to atmosphere, via the bypass control, 17, and the back pressure control, 15. Alternatively, when home heat exchanger positive displacement meter pumps, 11, are pumping more turbine exhaust gas, through the several exchangers, 10, than the gas turbine, 2, is producing, this deficiency of exhaust gas flow is made up by return flow of already cooled gas, from the collector pipe, 12, into the distribution pipe, 9, via the bypass control, 17.
12. This bypass control, 17, can function as a heating load sensor for a matching control, to match sensed district heating load of the several home heat exchangers, to the heating capacity of the water vapor saturated turbine exhaust gas, supplied to these heat exchangers. For example, when home heating load increases, and exceeds gas turbine exhaust gas heating capacity, the positive displacement meter pumps, 11, will increase turbine exhaust gas flow into the heat exchangers, above turbine exhaust gas flow out of the mixer and scrubber, 5, the bypass control, 17, will then return gas from the collector pipe, 12, into the distributor pipe. This motion of the bypass control gate, 21, of FIG. 3, can act as a sensor on the burner control, 19, to increase the delivery rate of fuel and compressed air into the burner, 4, and thus increase the turbine exhaust gas temperature. Increased turbine exhaust gas temperature will increase the water vapor content of the saturated mixer and scrubber exit gas, and thus increase the rate of water vapor condensation and heat transfer in the home heat exchanger, 10. In this way the heating capacity of the saturated turbine exhaust gas is matched to the heating load of the several home heat exchangers.
13. One particular example of a bypass control, 17, is shown schematically in FIG. 3, and comprises the following components:
   (a) Within a rectangular cross section pipe, 20, a gate, 21, is free to swing in either direction, about the centerline of its spindle, 22.
   (b) The gate sides, 24, and spindle end fit closely but freely with the adjacent surfaces of the pipe, 20, and can be fitted with labyrinth seal grooves, 23.
   (c) The gate end, 25, describes an arc, 26, when the gate moves in either direction relative to the curved pipe surface, 27.
   (d) With the gate, 21, centered at right angles across the pipe centerline, as shown in FIG. 3, the gap between the gate end, 25, and the curved pipe surface, 27, is very small, and provides only a small gas flow area. But as the gate swings in either direction, from this centered right angle position, the curved surface is so proportioned that an increasing gas flow area is created as the gate angle from the center position increases.
   (e) The weight of the gate, 21, or a torsion spring, acting on the gate spindle, 22, act to return the gate to the center position shown in FIG. 3.
   (f) The pipe, 20, end, 29, connects to the collector pipe, 12, and the end, 30, connects to the distributor pipe, 9.
   (g) The gate spindle, 22, drives a sensor of gate departure from the center position, and the direction of that departure, such as a rotary voltage divider.
   (h) Thus, when gas turbine exhaust flow exceeds the combined flows through the home heat exchangers, the resulting bypass flow, of excess turbine exhaust, will flow through the bypass control, from pipe end, 30, to pipe end, 29, and the gate, 21, will swing toward pipe end, 29. This gate motion, and resulting spindle sensor signal, can act, through the burner control, 19, and fuel delivery to reduce fuel burn rate. The consequently reduced turbine exhaust gas temperature will evaporate less water in the mixer, and the resulting reduced condensation in the home heat exchangers will cause the home meter pumps to increase gas flow into the heat exchangers, until turbine exhaust gas flow again equals the combined flows through the home heat exchangers.
   (i) When the combined flows through the home heat exchangers exceeds the turbine exhaust gas flow, the flow through the bypass control is reversed, and the gate swings toward pipe end, 30. This gate motion then acts, via the burner control, 19, to increase fuel delivery and fuel burn rate, as needed to again match turbine exhaust flow to combined heat exchanger flow.
   (j) This bypass control, 17, can thus function as a sensor of total home heating load, and operate to adjust fuel burn rate, to match turbine exhaust energy content to home heating load.
14. Sufficient liquid water needs to be sprayed into the mixer and scrubber, 5, to preferably secure saturation of the turbine exhaust gas when it leaves the mixer. Additional spray water may be used to scrub out acid components formed from fuel sulfur and nitrogen. An approximate energy and material balance calculation, for the mixer and scrubber, 5, yields the relation shown on FIG. 4 for the mols of water evaporated to saturate one mol of turbine exhaust gas as a function of turbine exhaust gas temperature, (Tz° R), and mixer pressure (PD). The effect of mixer pressure (PD), is rather small. A sensor of turbine exhaust gas temperature (Tz° R) can thus be used as input to the water controller, 31, which controls the speed of the positive displacement water pump, 6, so that liquid water flow is proportioned to turbine exhaust gas temperature a shown on FIG. 4, to which is added a proportional amount of scrub water.
15. As the connected heating load increases, the bypass control increases fuel burn rate, and fuel energy input, to the burner, 4, to meet this heating load increase, as described hereinabove in section 13. Increase of fuel energy input increases turbine inlet temperature, as well as turbine exhaust temperature, Tz. But maximum turbine inlet temperature is limited by the turbine blade materials, and, in consequence, maximum useable turbine exhaust temperature, and maximum heating load, are also thusly limited. These district heating plant design limitations can be illustrated approximately with the following specific assumed gas turbine example operating conditions:
   (a) Compressor compression ratio 23 to 1
   (b) Compressor efficiency, 0.85
   (c) Maximum turbine inlet temperature, 2660° R
   (d) Turbine exhaust back pressure, 25 psia
   (e) Air inlet temperature 540° R (80° F.)
   (f) Turbine efficiency, 0.92
   (g) Fuel energy input is herein expressed as the fuel energy fraction (FEF), of the maximum useable fuel energy input, at maximum useable turbine inlet temperature. For this assumed example, maximum fuel energy input was about 11812 Btu per pound mol of air flow, at a fuel energy fraction (FEF)=1.0.
   (h) These calculated results are approximate, since variations of turbine efficiency, with (FEF), were neglected. This effect tends to increase heating capacity, relative to electric power, at low values of (FEF).
As thus calculated, approximately, the effect of fuel energy fraction (FEF), on turbine inlet and exhaust temperatures, is shown on FIG. 5. The corresponding heating load, and electric load, per pound mol of air flow, is shown on FIG. 6. The design limiting condition, at maximum turbine inlet temperature, is also shown on FIGS. 5 and 6.
16. The various sensor and control operations, described hereinabove, can be either hand operated or automatically operated, or a combination of hand and automatic operation. In most applications, fully automatic sensor and control operation will be preferred.
17. For a given total district heating load the required size of gas turbine engine can be estimated, in terms of the required compressor air flow, mg, in pound mols per hour, as the ratio of total heating load, in Btu per hour, divided by the design point heating capacity, in Btu per pound mol of turbine exhaust gas. The approximation is here made, that turbine exhaust mols equal compressor air mols, as would be approximately the case for a largely carbon containing coal fuel.
18. Some of the principal beneficial objects of all types of district heating and power systems are illustrated in FIG. 7. The fractional distribution of fuel energy, between electric energy and heating energy, as well as the total useful energy output, is shown, versus fuel energy fraction input. Between 70 and 90 percent of the fuel energy is utilized fully for heating and electric power. Low cost coal can be substituted for expensive heating oil and natural gas for home heating. Such substitution of coal, for petroleum fuels, would improve national energy independence, since known national coal reserves greatly exceed known petroleum reserves. Our national adverse trade imbalance would be substantially reduced by thusly reducing petroleum imports.
19. For these reasons, district heating systems are in widespread use in several European countries, but are very little used in the United States. Almost all of these prior art district heating systems use high pressure steam boilers, and steam turbines, for electric power generation, with the turbine exhaust steam providing the heating, either directly, or by producing hot water for distribution to the heating load. Such high pressure steam boiler systems require constant attendance of several qualified operators, with consequent high operating costs. For this reason many of these prior art district heating systems use single, very large, plants to serve an entire city, in order to reduce operating costs per unit of output. Such large steam boiler and turbine plants, with a large distribution system, require a large capital investment, with a long time interval for installation, before any returns are realized. It is perhaps for these financial reasons that very few district heating and power systems exist in the United States. Many of these large district heating and power systems in Europe are municipally owned, and tax financed.
20. A coal fired gas turbine district heating system, of this invention, offers several advantages over the conventional, high pressure, steam boiler and turbine, district heating system, as follows:
   (a) The plant operation can be fully automated, with very small personnel operating costs, per unit of output. Plant pressures are moderate, creating very little public hazard.
   (b) Individual plants can be of small or moderate size, requiring a smaller capital investment, with a shorter installation time, and earlier returns on capital.
   (c) A large city or district can be served by several separate, but interconnected, plants, and these installed, one at a time, over a period of years, with returns coming in soon from the early plants. System reliability is improved with several plants over a single large plant.
21. The fractional distribution of fuel energy, between heating and electric power, shown on FIG. 7, is estimated for the particular compressor pressure ratio of 23 to 1. At lower compressor pressure ratios, the heating capacity will increase relative to the electric power. This selection of compressor pressure ratio is another plant design factor which can be used to better match plant output to the district heating and electric power demands.
22. The heating capacity of a coal fired gas turbine district heating plant of this invention, can be substantially increased, above the design point, if needed to meet unexpected or long term heating load increases, by increasing the exhaust back pressure, PD, of the system. As shown on FIG. 8, heating load capacity, beyond the design point, can be greatly increased, but at a loss of electric power capacity. As back pressure, PD, is increased, by reducing the flow area of the back pressure control, 15, incomplete gas expansion through the turbine, 2, elevates the turbine exhaust temperature, (Tz), and a greater quantity of liquid water can be evaporated in the mixer, and then condensed in the heat exchanger, to increase the heating capacity. But such incomplete gas expansion through the turbine reduces turbine power and hence also electric power. Overall plant efficiency remains high, electric power being lost to heating capacity.
   B. Split Turbine Option

A modified form of the invention is shown schematically in FIG. 9 and related FIG. 10. The following elements are similar to those shown in FIGS. 1 and 2, as described hereinabove, and are correspondingly numbered:

a. Air compressor, 1, for the gas turbine engine;

b. Induction generator, 3;

c. Fuel burner, 4;

d. Distribution pipe, 9;

e. Home heat exchanger, 10;

f. Positive displacement meter pump, 11;

g. Home heat exchanger condensate trap, 14;

h. Home thermostat control of the positive displacement meter pump, 16;

i. Positive displacement water pump for delivering liquid water into the mixer, 6;

j. Water controller for controlling the mixer water pump, 31;

k. Burner control for gas turbine engine 19;

l. Home air pump, 50;

The gas turbine engine is split into a high pressure turbine, 32, and a low pressure turbine, 33. The high pressure turbine, 32, receives the hot burned gases from the burner, 4, diluted with the bypass compressed air, as input to the entry nozzles. The exhaust gas from the high pressure turbine, 32, is split into a mixer flow, (mgM), to the mixer, 34, and a low pressure flow (mgL), to the nozzle control, 35, at entry to the low pressure turbine, 33. The nozzle control, 35, adjusts the flow area of the low pressure turbine entry nozzles, in order to maintain an essentially constant set value of exhaust pressure, PD, on the high pressure turbine, and on the mixer, 34. This nozzle control, 35, could be a throttling control, or preferably a nozzle flow area control, responsive to a sensor of the high pressure turbine exhaust pressure, (PD). The exhaust gas from the low pressure turbine, 33, at essentially atmospheric pressure, (PI), can be discharged directly to atmosphere, or, alternatively, used to preheat the bypass compressed air, the mixer water, and the scrubber water, as described hereinbelow.

By thusly splitting the turbine, a high pressure, and high temperature, gas can be supplied into the distribution piping, without sacrificing potential electric power output. Smaller size distribution system pipes and smaller home heat exchangers can be used with these higher pressures and temperatures. Also gas collector piping is not required. Against these several benefits of the split turbine option, is to be set a loss of overall energy efficiency, since the exhaust gas energy from the low pressure turbine may be lost in part.

In some district heating applications, concurrent heating and cooling may be needed, as, for example, in some high rise, glassy, office buildings. The low pressure turbine exhaust gas, after water vapor saturation and scrubbing, could serve as a heat source for an absorption refrigeration system, to supply the cooling capacity needed for these applications.

The mixer, 34, and scrubber, 36, can be separated, so that scrub water containing additives, such as acid neutralizing bases, can be used to improve removal of acidic materials, formed from the combustion of sulfur and nitrogen in fuels such as coal. In this way the mixer flow, (mgM), can be fully saturated with water vapor, from liquid mixer water free of additives, while passing through the mixer, 34, and prior to entering the scrubber, 36. The scrub water pump, 37, delivers liquid scrub water into the separate scrubber chamber, 36. This scrub water does not evaporate into the already saturated mixer flow (mgM), but is removed, as liquid, by the scrub liquid trap, 39, after passing through the scrubber, 36, to remove particulates and acids from the mixer flow. The scrub control, 40, can adjust the scrub water flow rate (ms), pumped by the scrub pump, 37, to be proportional to the fuel flow rate into the burner, 4, the gas flow rate into the mixer, and the sulfur and nitrogen content of this fuel. Thus, when a fuel, free of sulfur and nitrogen, such as natural gas, is being supplied to the burner, 4, scrub water will only be needed to remove nitrogen oxides formed from the combustion air. On the other hand, when using a high sulfur coal in the burner, more scrub water can be used to remove the consequently larger quantity of acid products of fuel combustion.

Cold scrub water will somewhat chill the mixer flow, and thus reduce the water vapor content, and home heating capacity, thereof. This loss of capacity can be offset by preheating the scrub water, at pressure beyond the scrub pump, 37, using a portion of the low pressure turbine exhaust gas in a heat exchanger, 41, as shown on FIG. 9.

Additional home heating capacity can be gained by similarly preheating the liquid mixer water being pumped into the mixer, by use of a preheater, 47, using another portion of the low pressure turbine exhaust gas, as shown on FIG. 9.

Such preheat of mixer water and scrub water increases plant cost by the cost of the heat exchangers and controls. However, this added cost may be offset by the resulting capacity increase.

The fuel efficiency of the plant can be increased by preheating that portion of the compressed air which bypasses the fuel burner, 4, using a preheater, 49, through the cold side of which this compressed air flows, and through the hot side of which the low pressure turbine exhaust gas flows, as shown on FIG. 9.

The operation of the home heat exchanger system shown in FIG. 10, is essentially similar to that shown in FIG. 2, except that a collector pipe, and bypass control, are not needed. With the split turbine arrangement shown in FIG. 9, any high pressure turbine exhaust gas, not used in the several home heat exchangers, 10, is directed by the nozzle control, 35, into the low pressure turbine, 38, in order to maintain a steady distribution system set pressure, (PD). Each home heat exchanger, 10, in FIG. 10, is fitted with a back pressure valve, 42, to maintain heat exchanger pressure somewhat below distribution pressure, (PD). By thus eliminating the collector pipe, the cost of a district heating system, using the split turbine scheme shown in FIG. 9, is reduced.

The term split ratio (SR) is herein defined as the fraction, of total high pressure turbine exhaust gas, which flows into the low pressure turbine. The nozzle control, 35, has a finite minimum nozzle flow area, so that at least some high pressure turbine exhaust gas always flows through the low pressure turbine, and the operating split ratio always exceeds zero.

C. Split Turbine Controls

The split turbine plant, shown schematically in FIGS. 9 and 10, can be controlled in various ways, to assure a supply of the required heating load. An example control plan A is described herein, to illustrate one particular control plan, to assure a supply of both the required heating load, and at least a portion of the required electric load, for the district.

The induction generator, 3, of the split turbine plant of FIGS. 9 and 10, is connected to the electric power grid, and to the separate district electric power distribution wiring, as shown in FIG. 13. A comparator controller, 43, receives an input from the grid wattmeter, 44. The total electric power to the separately wired district is the sum of the generator watts and the grid watts. The comparator compares grid watts to a preset value for grid watts, and, when grid watts exceed this preset value, sends an input to the burner controller, 19, to increase the flow rate of compressed air and fuel in order to increase fuel burn rate, and fuel energy fraction (FEF), thus increasing turbine net shaft work, and generator watts. Turbine net shaft work, and generator watts, are thus increased, in part by higher turbine inlet temperature, (Ty), to the high pressure turbine, 32, and, in additional part, by the consequently reduced mixer gas flow, (mgM), needed to supply the heating load, with resulting increased gas flow (mgL) into the low pressure turbine, 33, via the nozzle controller, 35, to maintain the constant set value of distribution system pressure, (PD). When grid watts drop below the preset value the comparator, 43, acts to reduce fuel energy fraction. In this way grid watts are maintained at a preset value, the induction generator supplying the excess electric power required by the district.

The nozzle control, 35, on the low pressure turbine, 33, functions as a back pressure regulator to maintain an essentially constant distribution system pressure (PD). As heating load increases, the home metering pumps, 11, either increase rotational speed, or are turned on for longer time periods, thus acting to decrease distribution system pressure. The nozzle control, 35, consequently reduces low pressure turbine inlet nozzle flow area, to maintain the distribution system pressure. As a result mixer gas flow (mgM) is increased to meet the increased heating load. But net shaft work, and generator watts, are reduced at consequently reduced low pressure turbine gas flow (mgL), resulting in increased grid watts input. The comparator, 43, then acts to increase burner fuel flow, and (FEF), as described above. The comparator, 43, and low pressure turbine nozzle control, 35, thus function as a matching control, to match district heating load to the heating capacity of the water vapor saturated portion of high pressure turbine exhaust gas, which flowed through the mixer, 34, and into the home heat exchangers.

The mixer water control, 31, is responsive to both the mixer exhaust gas flow rate, (mgM) and the high pressure turbine exhaust gas temperature (TzH), and operates on the mixer water pump, 6, to pump sufficient water (mwM) into the mixer, 34, to fully saturate the mixer exhaust gas (mgM), with water vapor. For the air compressor, 1, and high pressure turbine operating conditions assumed hereinbelow, the calculated ratio of mixer water to high pressure turbine exhaust gas

$$\frac{( mwM )}{mg M} ,$$

is shown on FIG. 11, versus high pressure turbine exhaust gas temperature, (TzH° R), and for several values of distribution system pressure, (PD). The calculated effect of distribution system pressure (PD) is seen to be rather small, and a single control line could be used as an adequate approximation for proportioning mixer water flow rate to the product of high pressure turbine temperature times flow rate at mixer entry.

Various kinds of sensors, of high pressure turbine exhaust gas flow rate into the mixer, can be used, such as an array of pitot tubes. The calculated temperature (Tmx° F.) of the water vapor saturated mixer exit gas is shown on FIG. 12, versus high pressure turbine exhaust gas temperature, (TzH° R). These mixer exit gas temperatures are seen to be high enough for rapid condensing heat transfer, in the home heat exchangers, and low enough that parasitic heat losses can be kept small, with moderate distributor pipe insulation. Also shown on FIG. 12 is the variation of high pressure turbine exhaust gas temperature (TzH° R), for several values of distribution system pressure (PD) and fuel burn rate in the burner, 4, as indicated by fuel energy fraction (FEF). These calculated values are based on an approximate material and energy balance on the high pressure turbine, 32, and the mixer, 34.

The scrub water control, 40, is to be responsive to the fuel flow rate into the burner, 4, as indicated by fuel energy fraction (FEF) and is to be preset for the sulfur and nitrogen content of the fuel, and operates on the scrub water delivery pump, 37, to proportion scrub water flow (ms), to mixer exhaust gas flow

$$\frac{m s}{mg M} ,$$

fuel energy fraction (FEF), and the sum of fuel sulfur content plus fuel nitrogen content:

$$\frac{( m s )}{( mg M )} = \frac{( Mols Sulfur + Mols nitrogen )}{( Mols Carbon )} ( FEF ) ( KSC )$$

Suitable values for the arbitrary constant, (KSC) will depend upon the acid collecting efficiency of the scrubber, 36, spray pattern. For a given scrubber spray pattern, larger values of (KSC) will yield a more complete removal of the sulfur and nitrogen acids created by the fuel combustion process. The scrub water control, 40, can thus be responsive to a sensor of fuel flow rate, (FEF), such as the high pressure turbine inlet temperature (Ty° R) and a sensor of mixer exhaust gas flow, such as a pitot tube at mixer entry.

The scrub water control operates on the scrub water pump, 37, to increase scrub water flow (ms), in proportion to the product of, fuel burn rate, (FEF), mixer gas flow rate, (mgM), and fuel sulfur and nitrogen content.

The burner control, 19, responds to grid watts, as described hereinabove, and operates to decrease fuel energy fraction (FEF) when grid watts decrease below a preset value, by decreasing the compressed air and fuel flow rate into the coal bed in the burner, 4, and consequently increasing the compressed air flow bypassing the burner, thus reducing the high pressure turbine inlet temperature (Ty° R). Where a gas or liquid fuel is used in the burner, 4, the fuel flow rate, and compressed airflow rate, into the burner, 4, are to be decreased, when grid watts are below the preset value.

D. Split Turbine Plant Sizing

The useful products of a split turbine district heating plant, such as the example shown schematically in FIGS. 9 and 10, are an electric work output, from the generator, 3, and a home heating load output (HL) from the several home heat exchangers, 10, in the distribution system. Ideally the plant is to be sized to fully serve both of these outputs, as needed for the district being served. However, for control reasons, as described hereinabove, it may sometimes be preferable to draw a preset portion of the electric load from the connected grid, with the generator supplying the remainder of the electric load for the district.

The district heating plant is to be sized to supply the estimated maximum heating load (HL max) in Btu per hour, for all the homes and businesses within the district. Additionally, the plant may be capable of supplying all or most of the maximum electric load (EL max) in Btu per hour, for the district. Where the district electric distribution is also connected into the local electric power grid, the heating load can alone be plant size determining. Herein the gas turbine engine net shaft work (NSW) is used instead of the electric load (EL) and these are related by the generator efficiency:

$$( Max NSW ) = \frac{( EL max )}{( Fractional Generator Eff . )}$$

Additional characteristics of the district heating and electric power requirements, useful for plant sizing, are the following:
Maximum ratio,

$$\frac{NSW}{HL}$$
Minimum ratio

$$\frac{NSW}{HL}$$
Maximum concurrent load (HL)+(NSW), Btu/Hr

Various procedures can be used to size a district heating plant of this invention, to meet the heating load and electric power requirements of a district. The following sizing procedure is an illustrative example of one such approximate procedure:

The following gas turbine engine operating conditions are selected:
Compressor pressure ratio (P₂/P₁)
Air inlet temperature, T₁; and pressure, P₁
Compressor efficiency
Maximum turbine inlet temperature, (Ty)
Turbine efficiencies, high pressure and low pressure
Generator efficiency

For a particular district heating load, increased compressor pressure ratio, and turbine inlet temperature, make available an increased net shaft work, and electric power output. This benefit is to be compared to the greater plant cost of a higher pressure and temperature at high pressure turbine inlet.

For this illustrative example, the following gas turbine engine operating conditions were assumed:
Compressor pressure ratio, 23/1
Air inlet at 80° F., 540° R, 15 psia
Compressor efficiency, 0.85 fractional
Maximum turbine inlet temp., 2660° R
High pressure turbine efficiency, 0.92 fractional
Low pressure turbine efficiency, 0.80 fractional
Generator efficiency, 0.90 fractional

For these assumed operating conditions, the fuel energy rate, in the burner, 4, is to increase the gas enthalpy at high pressure turbine inlet (hy) by 11812 Btu per pound mol of gas, over the gas enthalpy, h₂, at compressor outlet, at maximum fuel burn rate, with fuel energy fraction (FEF)=1.0.

The fraction of the high pressure turbine, 32, exhaust gas flow (mg), which flows also through the low pressure turbine (mgL), is the split ratio (SR) which herein is assumed, conservatively, to remain within the limits, 0.25 (SR) 0.75.

At low values of split ratio, the net shaft work can become negative, requiring the undesirable use of grid electric power, to keep the turbines and compressor running at speed. At high values of split ratio, the heating capacity becomes very small. The fraction of high pressure turbine exhaust flow which flows into the mixer, 34, and the heating distribution pipe, 9, equals (1−SR).
(mgM)=(mg)(1−SR)

The molal air flow rate through the compressor, 1, and the molal gas flow rate through the high pressure turbine (mg) are herein assumed approximately equal, as would be the case if a largely carbonaceous fuel, such as coke, were being supplied to the burner, 4.

The plant operating characteristics, including the heating load, and electric power output, in Btu per pound mol of compressor air flow, mg, can be estimated by a cycle analysis of the gas turbines and compressor, together with separate energy balances on the several components of the plant. These estimated characteristics can be conveniently shown in graphical form, for the assumed operating conditions listed above, as follows:
FIG. 14: Net shaft work, per pound mol of compressor air, versus high pressure turbine exhaust pressure, at maximum fuel energy fraction;
FIG. 15: Heating load per pound mol of compressor air, versus high pressure turbine exhaust pressure, at maximum fuel energy fraction;
FIG. 16: Ratio of net shaft work to heating load, versus high pressure turbine exhaust pressure, at maximum fuel energy fraction;
FIG. 17: Total output energy, versus split ratio, at maximum fuel energy fraction, for high pressure turbine exhaust pressure of 55 psia;
FIG. 18: Heating capacity, per pound mol of gas flow through home heat exchangers, versus high pressure turbine exhaust pressure;
FIG. 19: Saturation water vapor content of gases entering home heat exchangers, versus high pressure turbine exhaust pressure;
FIG. 11: Mixer water flow rate per mol of mixer exhaust gas flow required for saturation at mixer exit;
FIG. 12: Mixer exit temperature caused by saturation of high pressure turbine exhaust gas, versus high pressure turbine exhaust gas temperature;

The operating value for the high pressure turbine exhaust pressure, and approximate distribution system pressure (PD) can be selected from FIG. 16 so that both the minimum ratio and the maximum ratio of net shaft work to heating load can be met, at maximum fuel energy fraction, and within a conservative useable range of split ratio, 0.25 (SR) 0.75.

The required compressor air flow, mg, at the selected operating value of (PD) can be estimated as follows:

$$Heating Load ( mg ) = \frac{( HL max )}{( \frac{HL}{mg} ) From Figure 15}$$

$$Use \frac{( HL )}{( mg )} at ( SR ) = 0.25 , and ( FEF ) = 1.0 ;$$

$$Net Shaft Work ( mg ) = \frac{( NSW ) max}{( \frac{NSW}{mg} ) From Figure 14}$$

$$Use ( \frac{NSW}{mg} ) at ( SR ) = 0.75 , and ( FEF ) = 1.0 ;$$

The larger value for compressor air flow (mg), is used to check that the ratio of maximum total load,

$$( \frac{NSW}{mg} ) + ( \frac{HL}{mg} )$$

to (mg), does not exceed plant capacity, as shown on FIG. 17. If necessary compressor air flow (mg) can be increased further to meet this total load requirement.

With gas throughflow, exhaust back pressure, and maximum inlet temperature, thusly estimated, the high pressure turbine, 32, can be sized by prior art methods. A conservative sizing of the low pressure turbine, 33, could assume that, for (SR)=1.0, the low pressure turbine throughflow equals that of the high pressure turbine. The induction generator, 3, is to be sized for resulting maximum net shaft work.

The fuel burner, 4, is to be sized for the maximum fuel burn rate at maximum high pressure turbine inlet temperature and fuel energy fraction (FEF)=1.0:

$$Maximum pound mols fuel per hr = \frac{( mg ) ( hymax - {h}_{2} )}{( Fuel Btu per pound mol )}$$

Wherein the gas enthalpies, hymax and h₂, are in Btu per pound mol of gas, from appropriate gas properties tables. For the operating conditions assumed hereinabove, the value of (hymax−h₂) is approximately 11812 Btu per pound mol.

The burner air metering pumps can be sized to deliver a combustion airflow into the burner, 4, somewhat greater than stoichiometric for the fuel to be used.

The mixer water pump, 6, is to be sized to delivery sufficient mixer water (mwM), into the mixer, 34, to fully saturate the maximum mixer gas flow (mgM max), at split ratio (SR)=0, or 0.25, for the selected distribution system pressure (PD), at fuel energy fraction (FEF)−1.0:

$$( mw M ) = ( \frac{mwM}{mg M} ) ( mg ) ( 1 - SR )$$

FIG. 11 can be used for values of

$$( \frac{mwM}{mg M} ) ,$$

required to saturate the high pressure turbine exhaust gas with water vapor, at maximum high pressure turbine inlet temperature;

The scrub water pump, 37, is to be sized to deliver scrub water (ms) proportional to maximum mixer and scrubber gas throughflow (mgM max), and fuel sulfur and nitrogen flow into the burner, 4;

$$( ms ) = ( mg M ) ( KSC ) ( FEF ) ( \frac{Mols S + Mols N}{Mols C} )$$

$$( mg M ) = ( mg ) ( 1 - SR )$$

The molal ratio of fuel sulfur, plus nitrogen, to fuel carbon, can be estimated from the fuel chemical analysis. For a “typical” bituminous coal this molal ratio has an average value around 0.025, but varies appreciably between coals.

Suitable values for the scrub water constant (KSC), are best determined experimentally, and vary with the efficiency with which the scrub water spray pattern, in the scrubber, 36, contacts, and captures, the sulfur and nitrogen acids, formed from the fuel sulfur and nitrogen content.

The meter pump, 11, is to be capable of delivering a flow of saturated gas (mgM1)+(mws1), needed to supply the maximum home heating load (HHL max), into each home heat exchanger, 10.

$$maximum ( mg M 1 ) = \frac{( HHL max )}{( \frac{HL}{mg M} ) max}$$

Calculated values for

$$( \frac{HL}{mg M} )$$

max, are shown in FIG. 18, at fuel energy fraction (FEF)=1.0, and for the selected value of distribution system pressure (PD);

$$Max ( mws 1 ) = max ( mg M 1 ) \frac{( mws )}{( mg M )}$$

Calculated values for

$$( \frac{mws}{mg M} ) ,$$

the water vapor to gas molal ratio, at scrubber exit, and heat exchanger entry, are shown in FIG. 19, at fuel energy fraction (FEF)=1.0, and for the selected value of distribution system pressure (PD);

Note that the molal ratio of water vapor to gas, at scrubber exit, is somewhat less than at mixer exit, due to cooling of the mixture by the scrub water.

The required meter pump, 11, volumetric capacity (MPVC) cu.ft. per hour, can be estimated as follows:

$$( MPVC ) = [ Max ( mg M 1 ) + maximum ( mws 1 ) ] \frac{( 1545 ) ( {Tsx}^{∘} R )}{( 144 ) P Dpsia )}$$

The mixture temperature, at scrubber exit (Tsx° R), can be adequately approximated as the mixture temperature at mixer exit, (Tmx° R), from FIG. 12, since the cooling effect of the scrub water only decreases the mixture temperature by two to three degrees R.

Sizing each home heat exchanger, 10, is preferably based on experimental data, for heat transfer conditions similar to those prevailing therein. Condensation of water vapor, out of a non-condensable gas, is limited by the rate of diffusion of the water vapor, from the bulk gas to the heat exchanger surface. The largest part of the heat, exchanged from the gas and water vapor, into the home air, occurs via condensation of the water vapor on the colder surfaces of the heat exchanger. Approximate estimates of the surface area needed in the heat exchanger, 10, can be made by assuming the temperature to be achieved by the gas and residual water vapor mixture, at exit from the heat exchanger, and the consequent water vapor quantity to be condensed. The condensation rate per unit area relations of Colburn and Hougen, as presented in “Heat Transmission,” McAdams, first edition, 1933, McGraw Hill, New York, page 277, can then be used to estimate the needed heat exchanger area.

Other methods for sizing a district heating plant can be used. For example, where a few standardized sizes of gas turbine engine are available, it may be preferable to size the district to fit one of the standard sizes of available gas turbines.

An illustrative example sizing calculation for a split turbine district heating plant yielded the results listed below for assumed loads as follows:

(a) Maximum district heating load=75×10⁶ Btu/Hr;

(b) Maximum district electric load=50×10⁶ Btu/Hr;
For which a net shaft load of 56×10⁶ Btu/Hr is needed at a generator efficiency of 90%;

(c) Maximum ratio

$$( \frac{NSW}{HL} ) 2.20$$

(d) Minimum ratio

$$( \frac{NSW}{HL} ) 0.50$$

(e) Maximum [(HL)+(NSW)]=100×10⁶ Btu/Hr

(f) Conservative useable range of split ratio: 0.25 SR 0.75;

(g) Gas turbine engine operating conditions as listed hereinabove;

(h) Operating high pressure turbine exhaust pressure selected to be 55 psia from FIG. 16;

(i) Required compressor air flow:
For maximum heating load

$$( mg HL ) = 11 \text{,} 900 \frac{lb . mols air}{Hr}$$
For maximum net shaft work

$$( mg NSW ) = 11 \text{,} 700 \frac{lb mols air}{Hr}$$
For maximum total load,

$$( Mg total ) = 14 \text{,} 600 \frac{lb mols air}{Hr}$$

Which is the design value as the highest;

$$( j ) Coal burn rate = \frac{1113 lb mols coal 12}{Hr} ; 13356 lbs \text{/} Hr ;$$

$$( k ) \begin{matrix}Burner air flow rate \\ at 30 \% excess air\end{matrix} = 6890 \frac{Lb mols burner air}{Hr} ;$$

$$( l ) Mixer water maximum flow rate = 6278 \frac{lb mols {H}_{2} O}{Hr}$$

$$13566 gallons per hour ;$$

(m) Scrub water maximum flow rate for scrubber constant assumed to be 8, and coal molal sulfur plus nitrogen ratio to carbon=0.025,

$$2929 \frac{lb mols {H}_{2} O}{Hr} ;$$

6310 gallons per hour;

(n) For a particular home heating load capacity of 100,000 Btu per hour, the meter pump volumetric capacity required is

$$2110 \frac{cu . ft .}{Hr} ;$$

(o) For a gas and water vapor temperature of 90° F., at home heat exchanger exit, a condensation rate of 83 lbsmass of steam per hour is required, for this home. Using the Colburn and Hougen relations of reference A, an estimated heat exchanger transfer area of between 90 ft² and 180 ft² appears to be adequate if home air and gas and water vapor, mass velocities of about 1000 lbsmass per hour per square foot of flow area are used.

Having thus described my invention what I claim is:

1. A district heating plant for supplying heat to homes and buildings within a district, and for generating electric power, and comprising:
a gas turbine engine comprising:
an air compressor means for creating a flow of compressed air, at a compressor discharge pressure greater than atmospheric, and comprising a compressor inlet from the atmosphere, and a compressor discharge outlet;
a source of fuel;
a fuel burner chamber means for burning fuel, and supplied with a portion of said flow of compressed air, from said air compressor discharge outlet, as required for burning said fuel within said burner chamber, to create a flow of hot burned gases out of said burner chamber, and comprising, an air inlet connection to said air compressor discharge outlet, a fuel delivery means for delivering fuel from said source of fuel into said fuel burner chamber, and a hot burned gas outlet;
an expander turbine means to produce a work output, and supplied at inlet with a mixture of said flow of hot burned gases, from said fuel burner, and that portion of said flow of compressed air remaining after supplying said flow of compressed air to said burner, and for expanding said mixture into at least one exhaust gas flow, at a turbine exhaust pressure less than said compressor discharge pressure, and greater than atmospheric pressure, and comprising, an outlet connection for said at least one exhaust gas flow, a turbine inlet connected to said air compressor discharge outlet and also to said fuel burner hot burned gas outlet;
an electric generator means for generating an electric power output;
means for mechanically connecting said expander turbine, to said air compressor, and to said electric generator, so that the work output, of said expander turbine, is used to drive said air compressor, and said electric generator;
electrical connecting means for connecting said electric generator to an electric load;
a source of liquid mixer water;
mixer chamber means for mixing a flow of said liquid mixer water into at least a portion of said turbine exhaust gas flow at essentially said turbine exhaust pressure, said mixer being supplied with a flow of said portion of turbine exhaust gas, so that said turbine II exhaust gas portion becomes mixed with, and preferably saturated with, water vapor, said mixer chamber comprising: an exhaust gas inlet connection to said at least one exhaust gas flow outlet connection of said expander turbine; a mixer water inlet into said mixer chamber; a mixer outlet for said mixture of water vapor and turbine exhaust gas;
mixer water delivery means for delivering mixer water, from said source of liquid mixer water, into said mixer water inlet of said mixer chamber;
a distribution pipe means for distributing said mixture of water vapor and turbine exhaust gas flow, from said mixer outlet, throughout said district to be supplied with heat, said distribution pipe comprising, an inlet connection to said mixer outlet of said mixer chamber, a number of outlet connections equal to the number of homes and buildings to be supplied with heat;
each home and building, within said district, which is to be supplied with heat from said district heating plant, being equipped with a home heat exchanger system means for exchanging heat, from said water vapor and turbine exhaust gas mixture, into the home and building air, said home heat exchanger system comprising:
a heat exchanger comprising, a hot gas side, a separate cold gas side, a hot gas side inlet, a hot gas side outlet, a liquid condensate outlet at the bottom of said hot gas side, a cold gas side inlet, a cold gas side outlet;
a meter pump means for transferring hot turbine exhaust gas, mixed with water vapor, from one of said distribution pipe outlets, into said hot gas side inlet of said heat exchanger;
air pump means for passing home and building air through the cold gas side of said heat exchanger from said cold gas side inlet to said cold gas side outlet;
back pressure control means for controlling the pressure within the hot gas side of each said heat exchanger to be above atmospheric pressure, and comprising an inlet connected to said hot gas side outlet of said heat exchanger, and an outlet into the atmosphere;
a receiver of condensed liquid;
liquid condensate trap means for removing condensed liquid water from the bottom of the hot gas side of said heat exchanger, and connected at inlet to said liquid condensate outlet of said hot gas side of said heat exchanger, and discharging liquid condensate into said receiver of condensed liquid;
a load sensor means for sensing the combined heating loads of all connected homes and buildings;
matching control means for matching the combined heating loads, of all connected homes and buildings within the district, to the heating capacity of said turbine exhaust gas portion which flowed through said mixer, and into said distribution pipe, said matching control means being responsive to said sensor of said combined heating load, and being operative to adjust the temperature and flow rate product, of that portion of said turbine exhaust gas which flows through said mixer chamber, and into said distribution pipe, to match said combined heating load;
whereby homes and buildings within the district can be heated, by creating a hot turbine exhaust gas, mixed with, and preferably saturated with, water vapor, and passing this gas through heat exchangers in each home and building, wherein home air is heated while exhaust gas is cooled, and the consequent condensation of a principal portion of the water vapor transfers heat rapidly into home air;
and further whereby electric power is generated.

2. A district heating plant, as described in claim 1, wherein said expander turbine expands said mixture of hot burned gases and compressed air into a single exhaust gas flow, at an exhaust gas pressure less than said compressor discharge pressure, and greater than atmospheric pressure:
and further comprising:
a source of liquid scrub water;
a receiver of scrub liquid;
scrub chamber means for spraying liquid scrub water into said flow of turbine exhaust gas containing water vapor, from said mixer chamber, before said exhaust gas flow passes into said distribution pipe, said scrub chamber comprising; an exhaust gas inlet connected to said outlet of said mixer chamber, an exhaust gas outlet connected to said inlet of said distribution pipe, a scrub liquid outlet at the bottom of said scrub chamber, a scrub liquid inlet into said scrub chamber;
said scrub chamber further comprising;
scrub water delivery means for delivering scrub water, at pressure, from said source of liquid scrub water, into said scrub liquid inlet of said scrub chamber;
scrub liquid trap means for removing scrub liquid from the bottom of said scrub chamber, and discharging scrub liquid into said receiver of scrub liquid, and connected to said scrub liquid outlet of said scrub chamber;
wherein said meter pump, of said home heat exchanger system, is a positive displacement pump;
wherein said back pressure control is a single back pressure control for all of said connected home heat exchanger systems in said district;
and additionally comprising:
a collector pipe means for collecting all of said cooled mixtures of turbine exhaust gas and water vapor, flowing from the hot gas side outlets of all of said home heat exchangers within said district, and comprising a number of inlet connections to said hot gas side outlets of all said home heat exchangers connected to said distribution pipe, and an outlet connection to said single back pressure control;
wherein said matching control means comprises:
a bypass control means, connecting said distribution pipe to said collector pipe, via a gated flow passage through which mixtures of turbine exhaust gas and water vapor can flow, in whichever direction a pressure difference exists;
a sensor of the direction of flow of said mixture of turbine exhaust gas and water vapor through said bypass control means;
a burner control means for controlling the rate of fuel burning in said fuel burner, responsive to said sensor of the direction of flow of turbine exhaust gas through said bypass control, and operative upon said fuel burner, to increase the rate of fuel burning by increase of fuel and compressed air flow thereinto, when turbine exhaust gas flows through said bypass control from said collector pipe into said distribution pipe, and to decrease the rate of fuel burning when turbine exhaust gas flows through said bypass control from said distribution pipe into said collector pipe;
and additionally comprising:
a sensor of the temperature of the turbine exhaust gas entering said mixer chamber;
wherein said mixer water delivery means further comprises a mixer water control means for controlling the rate of flow of mixer water into said mixer chamber, so that said turbine exhaust gas flow therethrough becomes preferably essentially fully saturated with water vapor, said mixer water control being responsive to said sensor or turbine exhaust gas temperature at mixer entry, said mixer water control being operative upon said mixer water delivery means to increase the flow rate of mixer water, when turbine exhaust temperature increases, and to decrease the flow rate of mixer water, when turbine exhaust temperature decreases;
and additionally comprising:
a sensor of fuel burn rate in said fuel burner;
wherein said scrub water delivery means further comprises a scrub water control means for controlling the flow rate of scrub water, into said scrub chamber, to be proportional to the fuel burn rate in said fuel burner, said scrub water control being responsive to said sensor of fuel burn rate, and being operative to increase the scrub water flow rate, when said fuel burn rate increases, and to decrease the scrub water flow rate, when said fuel burn rate decreases;
wherein said electric generator means is an induction generator of alternating current;
wherein said electrical connecting means for connecting said electric generator to an electric load, also connects said electric generator to an electric power grid system;
wherein said home heat exchanger system further comprises a home thermostat sensor and control means for sensing the temperature of home and building air leaving said cold gas side of said home heat exchanger, and for controlling the flow of said mixture of water vapor and turbine exhaust gas, through said hot gas side of said home exchanger, responsive to said sensed home air temperature, and operative to increase the product of meter pump speed times meter pump run time, when said home air temperature is less than a set value, and to decrease said product of meter pump speed times meter pump run time, when said home air temperature is greater than said set value;
whereby said home air temperature is maintained within narrow limits about said set value.

3. A district heating plant, as described in claim 1, wherein said expander turbine is a split turbine, and expands said mixture of hot burned gas and compressed air into two turbine exhaust gas flows, a high pressure turbine exhaust gas flow, and a low pressure turbine exhaust gas flow:
said split turbine comprising:
a high pressure turbine expander, which receives at inlet said mixture of hot burned gases, from said fuel burner, mixed with said flow of compressed air remaining after supplying compressed air to said burner, and which discharges a high pressure turbine exhaust gas flow, via a high pressure turbine exhaust outlet, at a high pressure turbine exhaust pressure, less than said compressor discharge pressure, and greater than atmospheric pressure;
a sensor of said high pressure turbine exhaust pressure;
a low pressure turbine expander, which receives at inlet at least a portion of said high pressure turbine exhaust gas flow, and which discharges a low pressure turbine exhaust gas flow into a low pressure turbine exhaust outlet, at a low pressure turbine exhaust pressure, less than said high pressure turbine exhaust pressure, and no less than atmospheric pressure; said low pressure turbine expander comprising inlet nozzles and a nozzle control means for controlling the flow area of said inlet nozzles; said low pressure turbine nozzle control means being responsive to said high pressure turbine exhaust pressure sensor, and being operative to increase said low pressure turbine inlet nozzle flow area, when said high pressure turbine exhaust pressure exceeds a set value, and to decrease said inlet nozzle flow area when said high pressure turbine exhaust pressure is less than said set value;
whereby said high pressure turbine exhaust pressure is maintained within narrow limits about said set value;
wherein that portion of said high pressure turbine exhaust gas flow, remaining after supplying said portion to the inlet of said low pressure turbine, is the portion which flows into said exhaust gas connection of said mixer, which is connected to said high pressure turbine exhaust outlet;
and further comprising:
a source of liquid scrub water:
a receiver of scrub liquid:
scrub chamber means for spraying liquid scrub water into said flow of that portion of said high pressure turbine exhaust gas which flowed into said mixer chamber to become mixed with water vapor, from said mixer chamber before said exhaust gas flows into said distribution pipe, said scrub chamber comprising; an exhaust gas inlet connected to said exhaust gas outlet of said mixer chamber, an exhaust gas outlet connected to said inlet of said distribution pipe, a scrub liquid outlet at the bottom of said scrub chamber, a scrub water inlet into said scrub chamber;
said scrub chamber further comprising:
scrub water delivery means for delivering scrub water, at pressure, from said source of liquid scrub water, into said scrub liquid inlet of said scrub chamber;
scrub liquid trap means for removing scrub liquid from the bottom of said scrub chamber, and discharging scrub liquid into said receiver of scrub liquid, and connected to said scrub liquid outlet of said scrub chamber;
wherein said meter pump, of said home heat exchanger system, is a positive displacement pump;
wherein said electric generator means is an induction generator of alternating current;
wherein said electrical connecting means for connecting said electric generator to an electric load, also connects said electric generator separately to an electric power grid system;
wherein said matching control means comprises:
an electric power grid wattmeter means for sensing the power flow from said separately connected electric power grid;
an electric power comparator and sensor means for comparing the power flow from said electric power grid, to a set value for said grid power flow, and for creating an increase sensor signal when said grid power flow exceeds said set value, and for creating a decrease sensor signal when said grid power flow is less than said set value;
a burner control means for controlling the rate of fuel burning in said fuel burner, by increasing the rate of flow of fuel and compressed air thereinto when fuel burn rate is to be increased, and by decreasing the rate of fuel and compressed air flow thereinto when fuel burn rate is to be decreased; responsive to said increase and decrease sensor signals from said electric power comparator; and operative to increase said rate of fuel burning when an increase sensor signal is received and to decrease said rate of fuel burning when a decrease sensor signal is received;
whereby the flow of electric power, from said separately connected electric power grid, is maintained within narrow limits about said set value, by adjusting fuel burn rate, and hence expander turbine power output, and hence electric generator power output, to meet changes in electric power requirements of said connected load;
and further comprising:
a sensor of the temperature of that portion of said high pressure turbine exhaust gas entering said mixer chamber;
a sensor of the flow rate of high pressure turbine exhaust gas entering said mixer chamber;
wherein said mixer water delivery means further comprises a mixer water control means for controlling the flow rate of mixer water, into said mixer, so that said high pressure turbine exhaust gas portion, which flows through said mixer, becomes essentially fully saturated with water vapor, said mixer water control being responsive to both, said sensor of high pressure turbine exhaust gas temperature, and said sensor of turbine exhaust gas flow rate into said mixer, said mixer water control being operative upon said mixer water delivery means, to proportion mixer water flow rate to the product of turbine exhaust gas temperature and flow rate, as illustrated, for example, on FIG. 11;
a sensor of fuel burn rate in said fuel burner;
wherein said scrub water delivery means further comprises a scrub water control means for controlling said scrub water flow rate, to be proportional to high pressure turbine exhaust gas flow rate into said mixer chamber, and also to be proportional to fuel burn rate in said burner, said scrub water control being responsive to said sensor of turbine exhaust gas flow rate into said mixer, and to said sensor of fuel burn rate, and to be operative upon said scrub water delivery means to proportion scrub water flow rate, to the product of turbine exhaust gas flow rate into said mixer times fuel burn rate;
wherein said home heat exchanger system further comprises a home thermostat sensor and control means for sensing the temperature of home and building air leaving said cold gas side of said home heat exchanger, and for controlling the flow of said mixture of water vapor and turbine exhaust gas, through said hot gas side of said home exchanger, responsive to said sensed home air temperature, and operative to increase the product of meter pump speed times meter pump run time, when said home air temperature is less than a set value, and to decrease said product of meter pump speed times meter pump run time, when said home air temperature is greater than said set value;
whereby said home air temperature is maintained within narrow limits about said set value.

4. A district heating plant as described in claim 2:
wherein said mixer chamber and said scrub chamber are combined into a mixer and scrubber chamber;
wherein said mixer water delivery means and said scrub water delivery means are combined into a mixer and scrub water delivery means.

5. A district heating plant as described in claim 3:
wherein each home heat exchanger system, of each connected home and building, is separately connected to a separate back pressure control.

6. A district heating plant as described in claim 5, and further comprising:
compressed air preheater means for preheating said flow of compressed air at compressor discharge, and comprising a heat exchanger comprising, a hot gas side with a hot gas inlet and a hot gas outlet, and a separate compressed air side with a compressed air inlet and a compressed air outlet, said hot gas side inlet connecting to said low pressure turbine exhaust, said hot gas side outlet connecting to atmosphere, so that a portion of said low pressure turbine exhaust gas flows through said hot gas side of said heat exchanger, said compressed air inlet connecting to the discharge of said air compressor, and said compressed air outlet connecting to both the burner air inlet and the high pressure turbine inlet, so that compressed air flows through the compressed air side of said heat exchanger, to be preheated by said low pressure turbine exhaust gas portion.

7. A district heating plant as described in claim 6, and further comprising:
mixer water preheater means for preheating said mixer water being delivered into said mixer chamber, and comprising a heat exchanger comprising, a hot gas side with a hot gas inlet and a hot gas outlet, and a separate mixer water side with a mixer water inlet and a mixer water outlet, said hot gas side inlet connecting to said low pressure turbine exhaust, said hot gas side outlet connecting to atmosphere, so that a portion of said low pressure turbine exhaust gas flows through said hot gas side of said heat exchanger, said mixer water inlet connecting to said mixer water delivery means, and said mixer water outlet connecting to said mixer chamber, so that mixer water flows through the mixer water side of said heat exchanger, to be preheated by said low pressure turbine exhaust gas portion;
scrub water preheater means for preheating said scrub water being delivered into said scrub chamber, and comprising, a heat exchanger comprising, a hot gas side with a hot gas inlet and a hot gas outlet, and a separate scrub water side with a scrub water inlet and a scrub water outlet, said hot gas side inlet connecting to said low pressure turbine exhaust, said hot gas side outlet connecting to atmosphere, so that a portion of said low pressure turbine exhaust gas flows through said hot gas side of said heat exchanger, said scrub water inlet connecting to said scrub water delivery means, and said scrub water outlet connecting to said scrub water chamber, so that scrub water flows through the scrub water side of said heat exchanger, to be preheated by said low pressure turbine exhaust gas portion.

8. A district heating plant as described in claim 3:
wherein said back pressure control is a single back pressure control for all said heat exchangers;
and further comprising:
a collector pipe means for collecting all of said cooled, water vapor saturated, turbine exhaust gas flow, from the hot gas side outlets of all of said connected heat exchangers within said district, and comprising, a number of inlet connections to the hot gas side outlets of all said heat exchanger systems connected to said distribution pipe, and an outlet connection to said single back pressure control.

9. A district heating plant as described in claim 8, and further comprising:
compressed air preheater means for preheating said flow of compressed air at compressor discharge, and comprising a heat exchanger comprising, a hot gas side with a hot gas inlet and a hot gas outlet, and a separate compressed air side with a compressed air inlet and a compressed air outlet, said hot gas side inlet connecting to said low pressure turbine exhaust, said hot gas side outlet connecting to atmosphere, so that a portion of said low pressure turbine exhaust gas flows through said hot gas side of said heat exchanger, said compressed air inlet connecting to the discharge of said air compressor, and said compressed air outlet connecting to both the burner air inlet and the high pressure turbine inlet, so that the compressed air flows through the compressed air side of said heat exchanger, to be preheated by said low pressure turbine exhaust gas portion.

10. A district heating plant as described in claim 9, and further comprising:
mixer water preheater means for preheating said mixer water being delivered into said mixer chamber, and comprising a heat exchanger comprising a hot gas side with a hot gas inlet and a hot gas outlet, and a separate mixer water side with a mixer water inlet and a mixer water outlet, said hot gas side inlet connecting to said low pressure turbine exhaust, said hot gas side outlet connecting to atmosphere, so that a portion of said low pressure turbine exhaust gas flows through said hot gas side of said heat exchanger, said mixer water inlet connecting to said mixer water delivery means, and said mixer water outlet connecting to said mixer chamber, so that mixer water flow through the mixer water side of said heat exchanger, to be preheated by said low pressure turbine exhaust gas portion;
scrub water preheater means for preheating said scrub water being delivered into said scrub chamber, and comprising, a heat exchanger comprising, a hot gas side with a hot gas inlet and a hot gas outlet, and a separate scrub water side with a scrub water inlet and water side with a scrub water inlet and a scrub water outlet, said hot gas side inlet connecting to said low pressure turbine exhaust, said hot gas side outlet connecting to atmosphere, so that a portion of said low pressure turbine exhaust gas flows through said hot gas side of said heat exchanger, said scrub water inlet connecting to said scrub water delivery means, and said scrub water outlet connecting to said scrub water chamber, so that scrub water flows through the scrub water side of said heat exchanger, to be preheated by said low pressure turbine exhaust gas portion.
